(19) United States
(12) Patent Application Publication
(10) Pub. No.: US 2005/0161339 A1
(43) Pub. Date: Jul. 28, 2005

(54) Methods and processes for the manufacture of polynucleate metal compounds and disinfectants

(76) Inventor: Richard Alan Haase, Missouri City, TX (US)

Correspondence Address: RICHARD A. HAASE (INVENTOR), 4402 RINGROSE DRIVE, MISSOURI CITY, TX, 77459, US

(21) Appl. No.: 11/041,329

(22) Filed: Jan. 24, 2005

Related U.S. Application Data
(63) Continuation of application No. PCT/US02/23651, filed on Jul. 25, 2002.
(60) Provisional application No. 60/307,824, filed on Jul. 25, 2001.
(60) Provisional application No. 60/386,596, filed on Jun. 5, 2002.

(51) Int. Cl. C01F 7/22; C25C 7/00; C25D 17/00

(52) U.S. Cl. 205/499; 423/462; 204/242

(57) ABSTRACT

The instant invention presents methods and processes for the preparation of polynucleate metal hydroxyl-halide complexes and of disinfectants. Methods and processes are presented for complexes having the general formula Mₓ(OH)_{y}H_{z}, where H is a halogen and M is at least one metal in either the +2 or +3 valence state and wherein M is added to the complex in the form of the metal halide acid solution, the base metal, the metal oxide or the metal hydroxide. The halogen raw material in a salt form is converted to an acid via H₂SO₄ and/or electrolysis. Production of H₂SO₄ and/or H₂SO₃ from elemental sulfur is presented, wherein the energy of formation of H₂SO₄ and/or H₂SO₃ may be at least a portion of the energy to produce at least one of: steam, electricity, halogen gas, oxygen (O₂), hydrogen (H₂), hydrogen peroxide (H₂O₂), NaOH, hypohalites, halites, halates, halide acid and halogen oxides.

### RELATED APPLICATION DATA

This application is a continuation of PCT/US02/23651 filed Dec. 5, 2002. This application claims priority of PCT/US02/23651 filed Dec. 5, 2002; U.S. Provisional Patent Application Ser. No. 60/307,824 filed Jul. 25, 2001 and of U.S. Provisional Patent Application Ser. No. 60/386,596 filed Jun. 5, 2002.

### BACKGROUND OF THE INVENTION

1. Field of the Invention

The instant invention relates to processes for the preparation of polynucleate aluminum hydroxyl-halide complexes and of disinfectants. The instant invention obtains simplified processes for the preparation polynucleate aluminum hydroxyl-chloride complexes, known as polynucleate aluminum compounds (PAC) and aluminum chlorohydrate (ACH), with ACH normally used to define products having basicities of over 50% and having a higher corresponding aluminum content. All of these complexes have the general formulation Alₓ(OH)_{y}Cl_{z}.

The instant invention also obtains simplified processes for the preparation of polynucleate metal hydroxy-halide complexes having the general formulation Mₓ(OH)_{y}H_{z}, where H is a halogen, preferably Cl, and M is at least one metal or group of metals in either +2 or the +3 valence state and wherein, M is added to the polynucleate aluminum hydroxy-halide metal complex in the form of the metal halide acid solution, the base metal, the metal oxide or the metal hydroxide.

As defined in this instant invention, the term metal polymer (MP) is meant to refer to any polynucleate aluminum or polynucleate metal(s) complex or compound, including those which do not contain aluminum.

These MP are intended for use in liquid solids separations, such as in water purification, sludge dewatering and paper production, as well as solids dewatering and similar dewatering applications, being delivered in solution or in solid form. These MP can be used in a variety of applications including water purification, antiperspirants, corrosion control, and conductivity. The applications for these MP are only limited by the inclusion metal(s) and the application mechanism of the associated product, whether that be in liquid, solid or dry form.

The instant invention obtains simplified processes for MP, wherein the halogen raw material is in a salt form and converted to acid form via either acidification with sulfuric acid (H₂SO₄) and/or sulfurous acid (H₂SO₃) or with electrolysis. The instant invention obtains improved processes for the manufacture of disinfectants, wherein the disinfectant contains an oxidative element or compound, and wherein the energy of manufacture is obtained from the energy of formation from at least one selected form a list comprising: sulfur dioxide (SO₂) from the burning of sulfur (S) in air or O₂, sulfur trioxide (SO₃) from the oxidation of SO₂, H₂SO₄ formation from SO₃, sulfurous acid (H₂SO₃) formation from SO₂, halide acid formation from the reaction of a metal halide with H₂SO₄ and/or H₂SO₃ and any combination therein.

The processes of the instant invention: use less expensive raw materials, manage heat and chemical energy more efficiently, have lower transportation costs and require less handling of hazardous chemicals thereby requiring significantly less manufacturing cost.

2. Description of the Prior Art and Background

PAC

Since the 1970's it has been known in the art to prepare polynucleate (or polynucleate) aluminum complexes, also known as aluminum polymers. The first products that showed promise were poly aluminum sulfates. Processes for the production of poly aluminum sulfates are disclosed in U.S. Pat. Nos. 4,284,611 and 4,536,665 and Canadian Patent Nos. 1,203,364; 1,203,664; 1,203665; and 1,123,306. In these patents, poly aluminum sulfate is produced by reacting sulfate solutions with sodium carbonate or sodium hydroxide to form an insoluble aluminum hydroxide gel, wherein soluble sodium sulfate is then removed.

U.S. Pat. No. 4,877,597 describes another process for the production of poly aluminum sulfate. This process eliminated the initial step of producing an aluminum hydroxide gel by reacting aluminum sulfate with sodium aluminate.

U.S. Pat. No. 3,544,476 discloses a process for the formation of a poly aluminum chloral-sulfate. It is prepared by first producing an aluminum chloride/aluminum sulfate solution and then basifying this solution with calcium carbonate of lime. The insoluble calcium sulfate is removed.

U.S. Pat. Nos. 2,196,016; 2,392,153; 2,392,153; 2,392,531; 2,791,486; 3,909,439, and 4,082,685 disclose processes for the production poly aluminum chloride (low basicity ACH). These processes involve reacting aluminum oxy-hydrates or aluminum hydroxy-hydrates with hydrochloric acid (HCl) under high temperature and pressure conditions.

U.S. Pat. Nos. 4,362,643 and 4,417,996 disclose processes for the production of poly aluminum-iron complexes. These processes involve reacting aluminum chloride/iron chloride solution with aluminum hydroxide or aluminum oxy-hydrates, as well as reacting a poly aluminum chloride with iron.

U.S. Pat. No. 4,131,545 discloses a process for the production of poly aluminum sulfate compounds by reacting aluminum sulfate with phosphoric acid and calcium sulfate. In the water industry, it is known at this time that PAC compounds containing sulfate are known to out perform aluminum salts, iron salts, PAC and ACH in water temperatures from approximately 34 to approximately 40° F.

The most common PAC is ACH. ACH is the most common PAC due to its higher aluminum content, which significantly increases the effectiveness of the PAC in operating temperatures over 40° F. U.S. Pat. Nos. 4,051,028 and 4,390,445 disclose process for the formation of a poly aluminum hydroxychloride (ACH). It is prepared by reacting aluminum chloride solution and aluminum hydroxide with calcium carbonate or lime. Insoluble calcium carbonate is removed. U.S. Pat. Nos. 4,034,067 and 5,182,094 disclose processes for the formation of a poly aluminum hydroxychloride. It is prepared by reacting aluminum chloride solution with alumina or aluminum hydroxide under conditions of high temperature and pressure.

U.S. Pat. No. 5,938,970 discloses a method of forming polynucleate bi-metal hydroxide complexes (2 metals are used). This process describes the use of a trivalent metal in combination with a divalent metal, wherein the trivalent metal is in an acid solution and is reacted with the oxide or hydroxide form of the divalent metal.

WO 97/11029 (PCT/US96/13977) and U.S. Pat. No. 5,985,234 disclose a method of forming polynucleate aluminum complexes, wherein sodium aluminate is required to be reacted with either aluminum chloride or aluminum chlorosulfate; the reaction is carried out under conditions of high shear agitation to minimize gel formation. The reaction is to be carried out at a temperature of under 50° C. producing a milky suspension which clears over time.

At this time, ACH is known to be prepared by four methods. The first method is by reacting alumina and/or aluminum hydroxide with aluminum chloride solution (ACS) in a single step process at elevated temperature or pressure or both. Alumina is defined in the instant invention as any mixture comprising primarily aluminum oxy-hydrates and/or aluminum hydroxy-hydrates as those occur in nature and as purified from raw bauxite. Raw bauxite is purified by the Bayer process which utilizes the amphoteric nature of aluminum, which allows aluminum to be soluble at high pH as well as at low pH. Other metals do not exhibit this characteristic. Thereby aluminum is purified from other metals at a pH of approximately greater than 10.0 and at high enough operating temperature to flow the aluminum oxy- and hydroxy-hydrates. The second method is by reacting HCl with an excess of alumina and/or aluminum hydroxide at elevated pressure and/or temperature. The third process is by reacting alumina and/or aluminum hydroxide with HCl and metal carbonates or metal oxides at elevated temperature and/or pressure. The fourth method, which is disclosed in U.S. Pat. No. 5,904,856, presents a method of acidifying cement in HCl or ACS. A consequence of the second and the third process is large amounts of non-reacted aluminum hydroxide material that have to be returned to the process, which makes the process considerably more expensive; A consequence of the third process is a frothing of the carbonates in the reaction vessel; further, these products do not dry well should one desire a dry final aluminum polymer. The first and fourth processes are very expensive requiring the transport of large quantities of ACS. The second, third, and fourth processes are very expensive requiring the transportation of large quantities of HCl. Depending upon the concentration, HCl is at least approximately 65 percent water and ACS is at least approximately 60 to 90 percent water, the transportation of HCl or ACS requires the transportation and handling of large quantities of water and is therefore not economical. A consequence of the fourth process is the cost of first preparing the sintered cement containing Al₂O₃ and CIO. A consequence of all these processes is a purity limitation of the bauxite, if bauxite is used, as metal impurities in some forms of bauxite cannot be polymerized in the PAC when the PAC is used for drinking water purification.

All of these PAC and MP patent(s) are incorporated herein as a reference. All of these processes are limited with regard to the starting materials. Per any of these processes, large amounts of HCl or ACS or other metal acid solution must be handled. Per any of these processes, to prepare the ACS, HCl must be used. In summary, all require transportation, storage, and handling of large quantities of hazardous chemicals.

None of these processes manage heat or chemical energy in an efficient manner. All of these processes require adding heat to the PAC or MP reactor and require heat in the preparation of alumina with no consideration given to the exothermic nature of either HCl or ACS formation. All of these processes require the preparation of HCl or delivery of HCl prior to ACS manufacture, while there are significant amounts of potential chemical energy available in the conversion of sodium chloride to HCl and in the conversion of aluminum to ACS utilizing HCl. Finally, none of these processes investigate either the use of H₂SO₄ and/or H₂SO₃ for the preparation of HCl or the very exothermic production of H₂SO₄ and/or H₂SO₃ from S, which also presents the ability to produce heat energy, steam and electricity.

Other than the lost energy and the cost of purchase, transported HCl leads to many issues, which include increased cost and environmental concerns. HCl has to be transported and suitable ventilation has to be arranged in order to eliminate the release of Hydrogen Chloride gas, HClg. Further, aqueous chlorine (Cl), or the chloride ion, is produced from aqueous HCl. The chlorine (CL₂) production process is an expensive one that requires drying and refrigeration prior to storage. The most significant issue with CL₂ is storage. CL₂ is an extremely hazardous chemical to store; therefore, storage of CL₂ is expensive. The hazardous nature of CL₂ has, in recent years, caused many water purification facilities to reevaluate the usage of CL₂ versus bleach or other disinfectants.

Upon contact with water, CL₂ forms both the chloride ion and the chlorite ion. The chlorite ions are decomposed into chloride ions with temperature. The addition of heat to large volumes of liquid is also very expensive. Moreover, HCl must be stored and transported in polymer-lined containers where the releases of HClg vapors must be controlled. In summary, the production and transportation of HCl and/or CL₂ is both expensive and hazardous.

ACS is formed by the reaction of HCl with aluminum hydroxide, alumina (aluminum hydroxide and/or aluminum oxide in either dry of hydrate form) or aluminum. While ACS can be prepared from bauxite, this is not preferred in most applications because the acidification of aluminum in bauxite to ACS can also acidify any other metal impurities that may be present in the raw bauxite. Formation of ACS also releases HClg, which must be controlled. This is an expensive process. Therefore, in summary, the current processes always provide complications leading to increases in the cost of the final product, as well as many safety concerns which must be managed.

Further, the drinking water industry is placing restrictions on the amount of soluble aluminum in the final water product. Industrial processes have for years restricted aluminum salt coagulation to eliminate soluble aluminum in the final purified water. PAC(s) do not produce soluble aluminum in the final water. MP's do not place a soluble metal into the water. Due to requirements in both potable and industrial water coagulation, a safer, simpler and more economical process is needed for the manufacture of PAC(s) and MP(s).

Disinfectants

Further yet, all applications of purified water are trying to eliminate the formation of chloro-organic compounds, which have been found to be at least one of: toxic, carcinogenic, teratogenic and any combination therein. The drinking water industry is limiting CL₂ and bleach disinfection, investigating alternative such as H₂O₂, O₂, ozone (O₃) and chlorine dioxide (ClO₂). The power industry has learned that those same chloro-organic compounds prematurely use demineralizer beds, investigating alternative such as H₂O₂, O₂, O₃ and ClO₂. The paper industry has learned that those same chloro-organic compounds are found in both the final paper product and in the plant wastewater, thereby requiring investigation of alternatives such as H₂O₂, O₂, O₃ and ClO₂. The manufacture of O₃ requires O₂, which is an expensive product of either cryogenic distillation of air or electrolysis of water. Also, ClO₂ is an extremely hazardous chemical to transport, thereby requiring on-site generation from other CL₂ compounds, such as bleach (hypochlorite), chlorite and chlorate.

While there are many methods to prepare H₂O₂, there are two primary chemical manufacturing processes: the hydroquinone (HQ) process and the sulfuric acid/electrolysis (SAE) process. Historically, SAE was the preferred process until the 1960's and 1970's wherein industry converted to HQ due to the operating cost savings of eliminating the electrical cost associated with SAE. However, by its nature, HQ has a limitation of organic contamination, which is due to the use of an organic chemical (hydroquinone) as a catalyst. Further, the discovery of chloro-organic toxicity has lead industry to require more pure forms of H₂O₂. In H₂O₂ manufacturing, membranes have been discussed as methods of H₂O₂ purification. U.S. Pat. Nos. 4,879,043 and 6,333,018 present the use of reverse osmosis membrane technology as a final purification step in the production of H₂O₂ manufactured by HQ. U.S. Pat. Nos. 5,215,665; 5,262,058 and 5,906,738 present the use of reverse osmosis membrane technology in combination with cationic resin technology as final purification steps in the production of H₂O₂ manufactured by HQ. U.S. Pat. Nos. 5,851,042 and 6,113,798 present the use of converting contaminant particles by reacting said particles with micro-ligands, then separating said reaction products with membranes as a final purification step in the production of H₂O₂ manufactured by HQ. U.S. Pat. No. 5,800,796 presents an electrochemical reactor wherein O₂ and H₂ are reacted across a conductive membrane containing reducing catalysts forming H₂O₂. This novel process eliminates HQ while simplifying the process H₂O₂ production. However, the potential for contamination of H₂O₂ with heavy metals from the reducing catalyst is significant. Heavy metals contamination eliminates the potential use of H₂O₂ in either the production of micro-circuitry or water purification. In addition, the potential safety issues from the reaction of very explosive O₂ and/or H₂ in an electrolytic environment preclude the potential use of this process at the end-use site. U.S. Publication 20040126313 teaches the use of membrane technology in combination with SAE; however, a source of electricity is not presented. None of these references present SAE with a source of electricity. All of these H₂O₂ patents are incorporated herein as a reference.

While there are many methods to prepare O₂, the separation of air into its component gases is performed by three methods: cryogenic distillation, membrane separation and pressure swing adsorption (PSA, which includes vacuum). Conventional cryogenic distillation processes that separate air into O₂, Argon (Ar) and nitrogen (N₂) are commonly based on a dual pressure cycle. Air is first compressed and is subsequently cooled, wherein cooling is accomplished by one of four methods: 1—vaporization of a liquid, 2—the Joule Thompson effect; 3—counter-current heat exchange with previously cooled warming product streams or with externally cooled warming product streams, and 4—the expansion of a gas in an engine doing external work. The cooled and compressed air is usually introduced into two fractioning zones. The first fractioning zone is thermally linked with a second fractioning zone which is at a lower pressure. The two zones are thermally linked such that a condenser of the first zone reboils the second zone. Air undergoes a partial distillation in the first zone producing a substantially pure N₂ fraction and a liquid fraction that is enriched in O₂. The enriched O₂ fraction is an intermediate feed to the second fractioning zone. The substantially pure N₂ from the first fractioning zone is used as reflux at the top of the second fractioning zone. In the second fractioning zone, separation is completed producing substantially pure O₂ from the bottom of the zone and substantially pure N₂ from the top. When Ar is produced or removed a third fractioning zone is employed. The feed to this third zone is a vapor fraction enriched in Ar which is withdrawn from an intermediate point in the second fractioning zone. The pressure of this third zone is of the same order as that of the second zone. In the third fractioning zone, the feed is rectified into an Ar rich stream which is withdrawn from the top, and a liquid stream which is withdrawn from the bottom of the third fractioning zone and introduced to the second fractioning zone at an intermediate point. Reflux for the third fractioning zone is provided by a condenser which is located at the top. In this condenser, Ar enriched vapor is condensed by heat exchange from another stream, which is typically the enriched O₂ fraction from the first fractioning zone. The enriched O2 stream then enters the second fractioning zone in a partially vaporized state at an intermediate point above the point where the feed to the third fractioning zone is withdrawn.

The distillation of air, a ternary mixture into N₂, O₂ and Ar may be viewed as two binary distillations. One binary distillation is the separation of the high boiling point O₂ from the intermediate boiling point Ar. The other binary distillation is the separation of the intermediate boiling point Ar from the low boiling point N₂. Of these two binary distillations, the former is more difficult, requiring more reflux and/or theoretical trays than the latter. Ar—O₂ separation is the primary function of the third fractioning zone and the bottom section of the second fractioning zone below the point where the feed to the third zone is withdrawn. N₂—Ar separation is the primary function of the upper section of the second fractioning zone above the point where the feed to the third fractioning zone is withdrawn. The ease of distillation is a function of pressure. Both binary distillations become more difficult at higher pressure. This fact dictates that for the conventional arrangement, the optimal operating pressure of the second and third fractioning zones is at or near the minimal pressure of one atmosphere. For the conventional arrangement, product recoveries decrease substantially as the operating pressure is increased above one atmosphere mainly due to the increasing difficulty of the Ar—O₂ separation. There are other considerations, however, which make elevated pressure processing attractive. Distillation column diameters and heat exchanger cross sectional areas can be decreased due to increased vapor density. Elevated pressure products can provide substantial compression equipment capital cost savings. In some cases, integration of the air separation process with a power generating gas turbine is desired. In these cases, elevated pressure operation of the air separation process is required. The air feed to the first fractioning zone is at an elevated pressure of approximately 10 to 20 atmospheres absolute. This causes the operating pressure of the second and third fractioning zones to be approximately 3 to 6 atmospheres absolute. Operation of the conventional arrangement at these pressures results in very poor product recoveries due to the previously described effect of pressure on the ease of separation. Previous work to cryogenically separate air into its components can be referenced in U.S. Pat. Nos. 5,386,692; 5,402,647; 5,438,835; 5,440,884; 5,456,083; 5,463,871; 5,582,035; 5,582,036; 5,596,886; 5,765,396; 5,896,755; 5,934,104; 6,173,584; 6,202,441; 6,263,700; 6,347,534; 6,536,234; 6,564,581; 5,341,646; 5,245,832; 6,048,509; 6,082,136; 6,499,312; 6,298,668; and 6,333,445. All of these patents are incorporated herein as a reference.

It is also well known in the chemical industry to separate air with membranes. Two general types of membranes are known in the art: organic polymer membranes and inorganic membranes. These membrane air separation processes are improved by setting up an electric potential across a membrane that has been designed to be electrically conductive. Previous work performed to separate air into its components with membranes can be referenced in U.S. Pat. Nos. 6,523,529; 6,761,155; 6,277,483; 5,820,654; 6,293,084; 6,360,524; 6,551,386; 6,562,104; 6,361,583; 6,565,626; 6,572,678; 6,572,679; 6,579,341; 6,592,650; 6,372,010; 5,599,383; 5,820,654; 5,820,655; 5,837,125; 6,117,210; 5,599,383; 5,902,370; 6,117,210; 6,139,810; 6,403,041; and 6,767,663. All of these membrane patents are herein incorporated as reference. While these patents present many innovations in membrane technology, yet none present wherein the energy of manufacture is obtained from the energy for separation is obtained from the formation from at least one selected form a list comprising: SO₂ from the burning of S in air or O₂, SO₃ from the oxidation of SO₂, H₂SO₄ formation from SO₃, H₂SO₃ formation from SO₂, halide acid formation and any combination therein.

It is also well known to separate air into O₂ and N₂ with PSA (herein to include vacuum swing adsorption). Previous work performed to separate air into its components with PSA can be referenced in U.S. Pat. Nos. 6,572,838; 6,761,754; 6,780,806; 3,793,931; 4,481,018; 4,544,378; 5,464,467; 5,810,909; 5,868,818; 5,885,331; 6,350,298; 6,171,370; 6,423,121; 6,649,556; 6,652,626; 4,013,429; 4,264,340; 4,329,158; 4,685,939; 5,137,548; 5,152,813; 5,258,058; 5,268,012; 5,354,360; 5,413,625; 5,417,957; 5,419,891; 5,454,857; 5,672,195; 6,004,378; 6,357,601; 6,321,915; 6,315,884; 6,298,664; 6,497,098; 6,510,693; and 6,516,787. All of these PSA patents are herein incorporated as reference. While these patents present many innovations in PSA technology, none present wherein the energy of manufacture is obtained the formation energy of at least one selected form a list comprising: SO₂ from the burning of S in air or O₂, SO₃ from the oxidation of SO₂, H₂SO₄ formation from SO₃, H₂SO₃ formation from SO₂, halide acid formation and any combination therein.

An additional method for the manufacture of O₂ is the electrolysis of water (H₂O). Previous work in the electrolysis of H₂O can be referenced in U.S. Pat. Nos. 6,723,220; 5,585,882; 6,572,759; 6,551,735; 6,471,834; 6,361,893; 6,338,786; and 6,336,430. All of these electrolysis patents are herein incorporated as reference. While these patents present many innovations in electrolysis technology, none present wherein the energy of manufacture is obtained from the energy of formation from at least one selected form a list comprising: SO₂ from the burning of S in air or O₂, SO₃ from the oxidation of SO₂, H₂SO₄ formation from SO₃, H₂SO₃ formation from SO₂, halide acid formation and any combination therein.

It is well known in the art of methods and processes to manufacture oxides of halogens to form said halogen oxide from a metal/halogen salt via electrolysis. While the most common metal is sodium, calcium is often used. While the most common halogen is chlorine, bromine, fluorine and iodine are often used. Previous work in the production of halogen oxide manufacture can be referenced in U.S. Pat. Nos. 5,342,601; 5,376,350; 5,409,680; 5,419,818; 5,423,958; 5,458,858; 5,480,516; 5,523,072; 5,565,182; 5,599,518; 5,618,440; 5,681,446; 5,779,876; 5,851,374; 5,858,322; 5,916,505; 5,972,196; 6,004,439; 6,203,688; 6,306,281; 6,436,435; 6,740,223; 6,761,872; 6,805,787; and 6,814,877. All of these patents in the preparation of an oxide form of a halogen are herein incorporated as reference. While these patents present many innovations in the production of halogen oxides, none present wherein the energy of manufacture is obtained from the energy of formation from at least one selected form a list comprising: SO₂ from the burning of S in air or O₂, SO₃ from the oxidation of SO₂, H₂SO₄ formation from SO₃, H₂SO₃ formation from SO₂, halide acid formation and any combination therein.

Acid Manufacture—Sulfuric, Sulfurous and Hydrochloric

HCl is known in the art to be produced by 2 processes, the Electrolysis Unit (EU) process and the Sulfuric Acid Process (SAP). The raw materials for EU production of HCl include sodium chloride, water, and electricity. The raw materials for SAP production of HCl include sodium chloride, H₂SO₄ and water.

H₂SO₄ is manufactured primarily by two competing processes, the condensation process and the contact process. In both cases, S is combusted in air and/or O₂ to produce SO₂. SO₂ is then converted into SO₃ in the contact process with the use of a catalyst, usually V₂O₅, in the presence of excess air at a temperature of near 400-450° F. In either process, SO₃ can be slowly converted into H₂SO₄ by contact of said SO₃ with H₂O. In the condensation process, the combusted SO₂ is contacted with H₂O quickly forming H₂SO₃ and slowly forming H₂SO₄. In the contact process, said SO₃ is contacted with H₂SO₄ forming H₂S₂O₇ (oleum); oleum is then contacted with H₂O forming 100 percent H₂SO₄. It is difficult to obtain 100 percent H₂SO₄ with the condensation process.

Transportation of Hazardous Chemicals

As population density increases, the transportation of hazardous chemicals, including acids and disinfectants, becomes more hazardous and dangerous. While solutions of halide acids, hypohalites and halites are safer disinfectants for transportation, handling, and storage, the cost of manufacture of these disinfectants has limited their use. A more economical process is also requires for the manufacture of O₂, ClO₂, halide acids, hypohalites, and halates.

### SUMMARY OF THE INVENTION

A primary object of the instant invention is to devise an effective, efficient, and economically feasible process for producing polynucleate aluminum and/or polynucleate metal complexes.

Another object of the instant invention is to devise an effective, efficient, and economically feasible process for producing polynucleate aluminum and/or polynucleate metal complexes without the transportation and handling of hazardous materials.

Still another object of the instant invention is to devise an effective, efficient, and economically feasible process for producing polynucleate complexes that contain metals in addition to and/or instead of aluminum.

Still yet another object of the instant invention is to devise an effective, efficient, and economically feasible process for producing disinfectants and/or oxidants, preferably those utilized in the water treatment and the paper industries, specifically: O₂, O₃, H₂O₂, NaOH, hypohalites, halites, halates, halogen oxides and halide acids.

Still further yet another object of the instant invention is to devise an effective, efficient, and economically feasible process for producing HCl and H₂SO₄., as well as metal sulfites, metal bisulfites and metal sulfates.

### BRIEF DESCRIPTION OF THE DRAWINGS

A better understanding of the instant invention can be obtained when the following preferred embodiments are considered in conjunction with the following drawings, in which:

FIG. 1 illustrates in block diagram form a general description of a preferred embodiment of the proposed methods and processes to manufacture disinfectants with electrolysis, wherein the energy for electrolysis is obtained from the formation of at least one selected from a list comprising: SO₂, SO₃, H₂SO₃, H₂SO₄ and any combination therein.

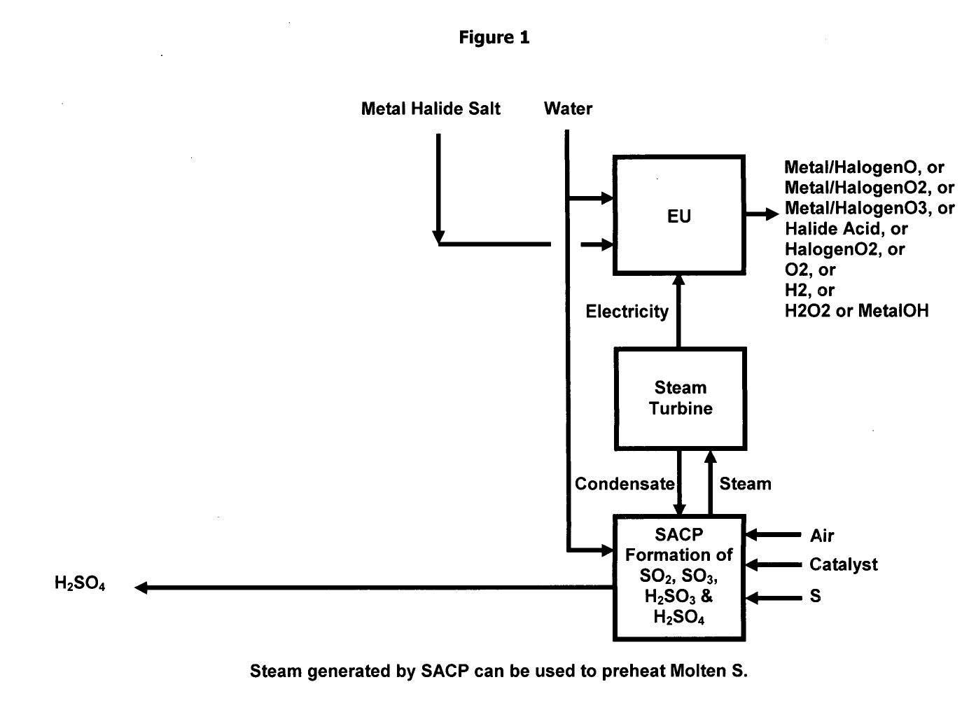

FIG. 2 illustrates in block diagram form a general description of a preferred embodiment of the above methods and processes in combination with an SAP, wherein H₂SO₄ and/or H₂SO₃ is reacted with a metal/halide salt to form the corresponding halide acid, along with the corresponding metal sulfate, sulfite or bisufite.

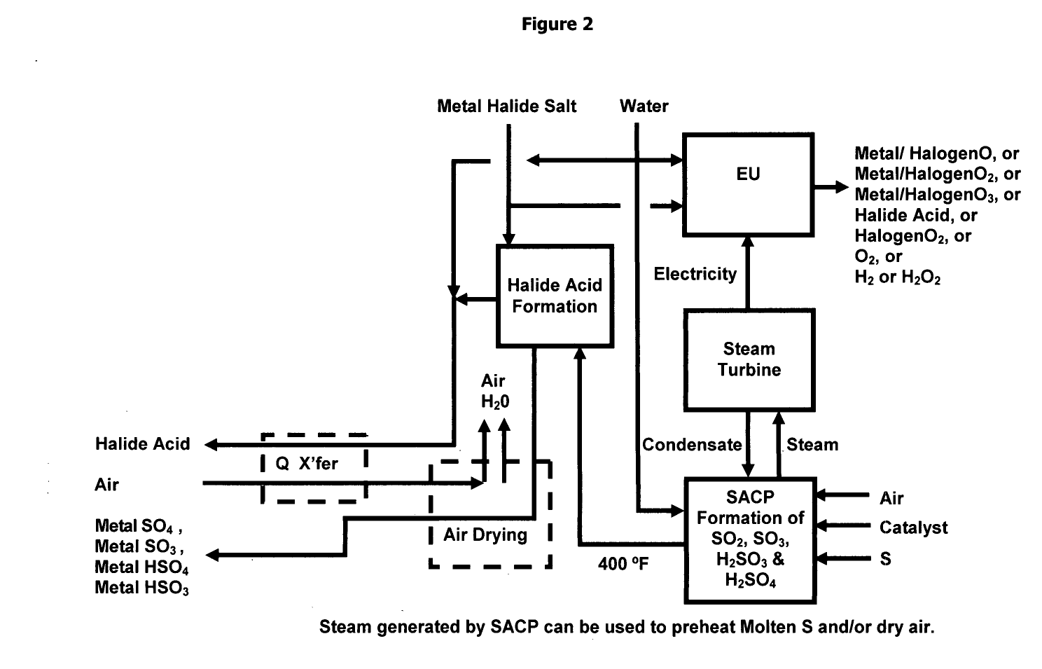

FIG. 3 illustrates in block diagram form a general description of a preferred embodiment of all of the above methods and process in combination with the manufacture of a PAC and/or an MP.

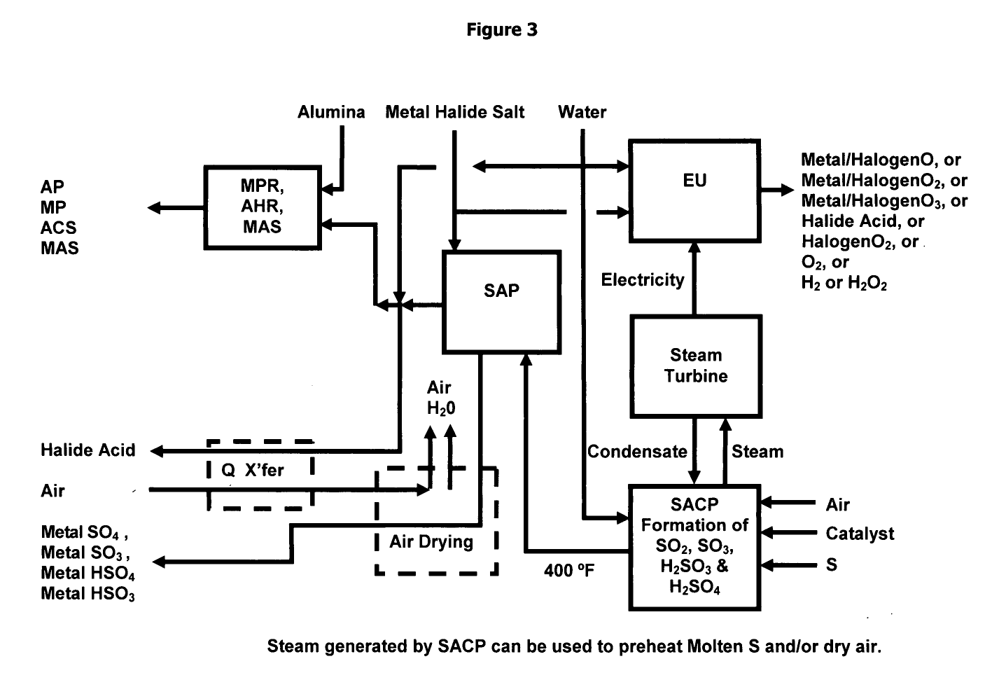

FIG. 4 illustrates in block diagram form a general description of a preferred embodiment, wherein the H₂ produced in electrolysis is recycled as an energy source for electrolysis to improve the economics of electrolysis.

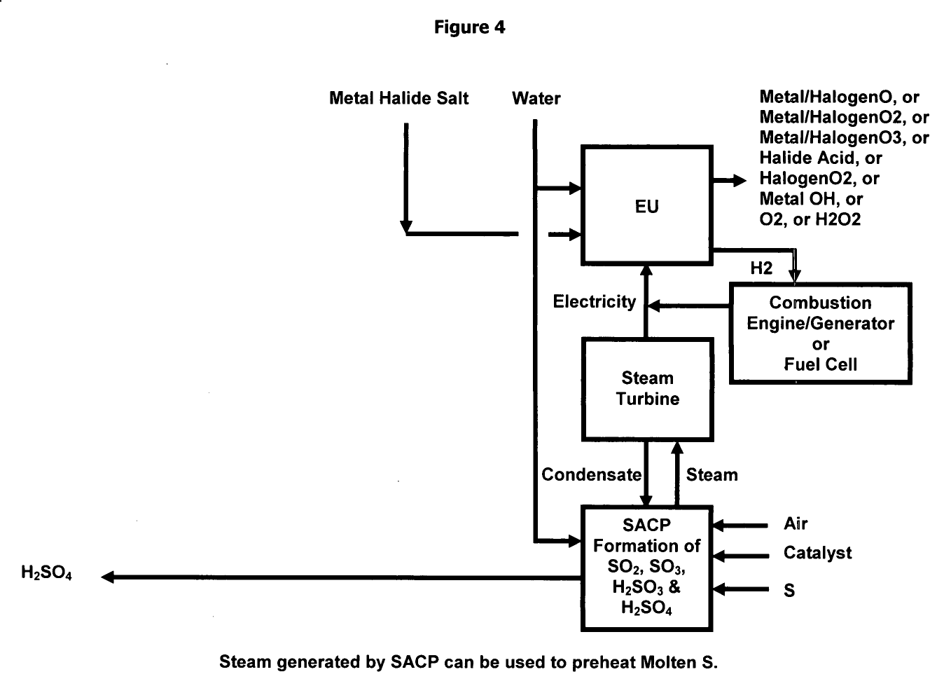

FIG. 5 illustrates in block diagram form a general description of a preferred embodiment comprising a steam turbine, wherein air separation, preferably cryogenic distillation, is used to produce O₂.

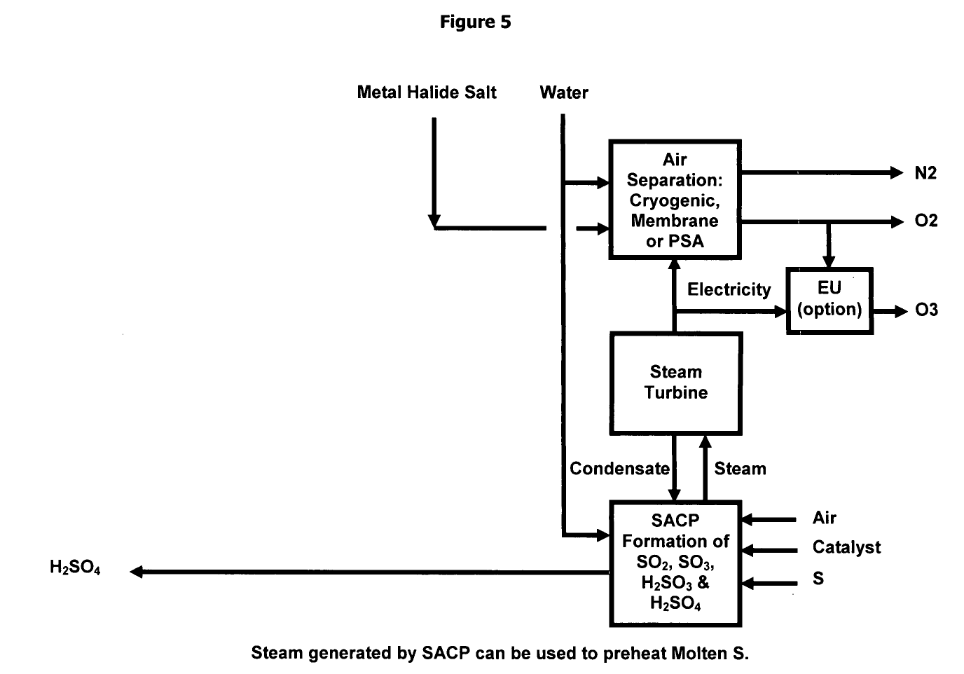

FIG. 6 illustrates in block diagram form a general description of a preferred embodiment comprising a steam engine, wherein air separation, preferably cryogenic distillation, is used to produce O₂.

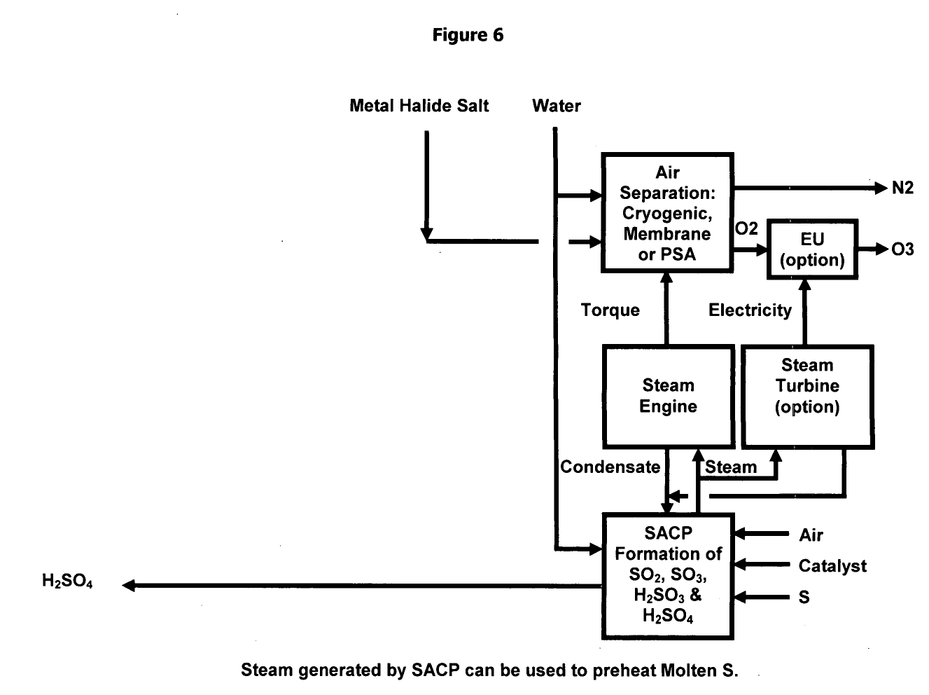

FIG. 7 illustrates in block diagram form a general description of a preferred embodiment, wherein the H₂ produced in electrolysis is recycled as an energy source for electrolysis to improve the economics of electrolysis.

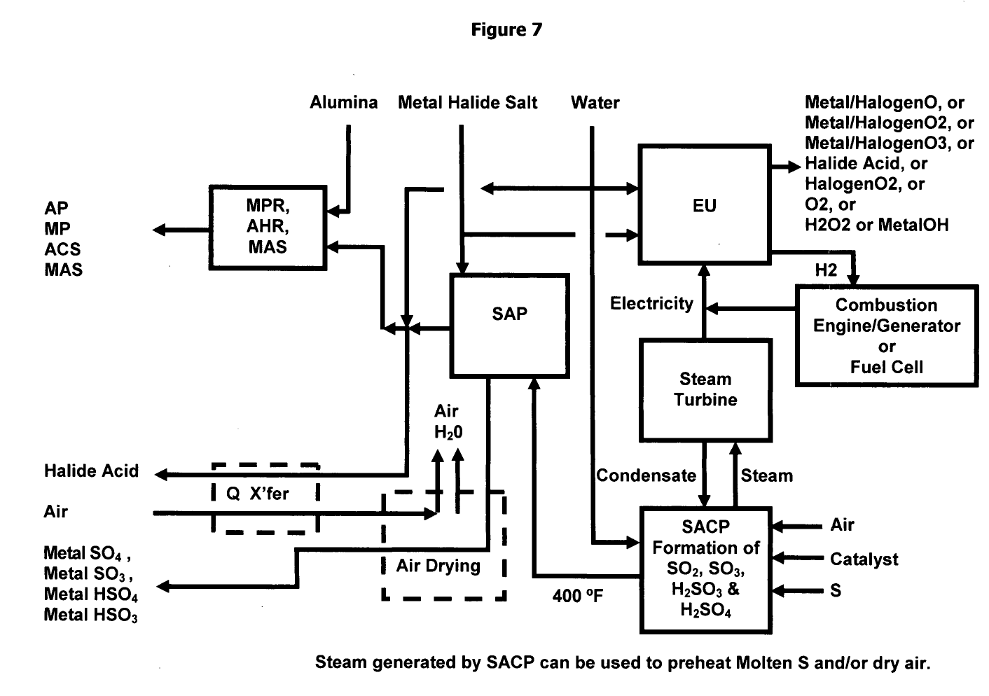

FIG. 8 illustrates in block diagram form a general description of a preferred embodiment, wherein air separation, preferably, cryogenic distillation is used to produce O₂.

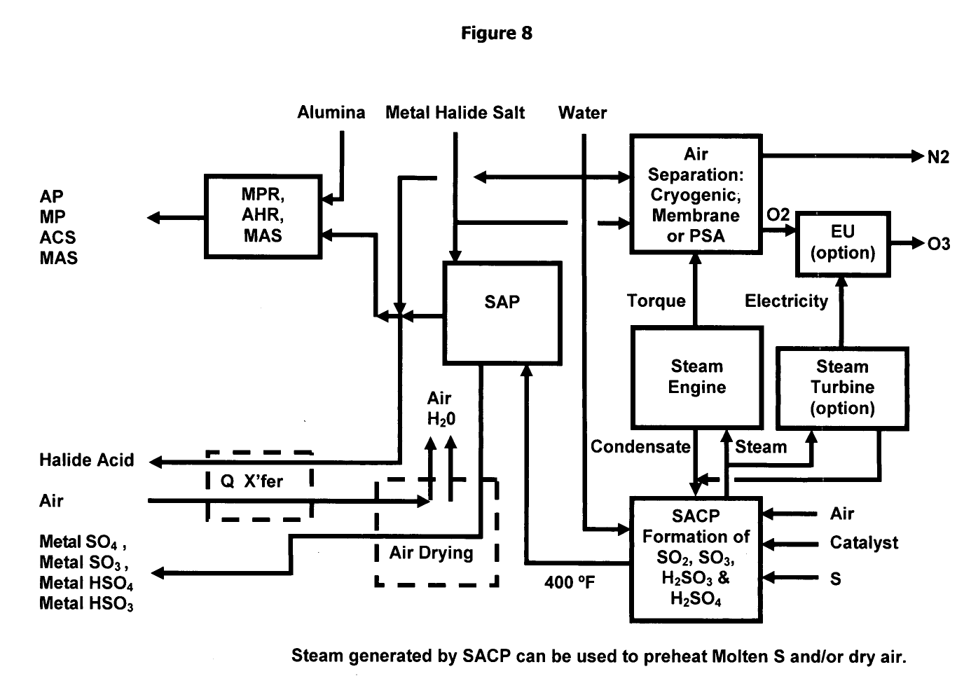

### DESCRIPTION OF THE PREFERRED EMBODIMENTS

Polynucleate aluminum compounds and polynucleate metal compounds, whether or not containing aluminum are both referred to as metal polymers (MP(s)). MP(s) as used herein refer to polynucleate aluminum compositions such as aluminum chlorohydrate, aluminum hydroxychloride, aluminum hydroxyhalide, polyaluminum hydroxysulfate and polyaluminum hydroxychlorosulfate, polyaluminum hydroxyhalosulfate polyaluminum hydroxy sulfate calcium chloride, polyaluminum hydroxy sulfate calcium halide, polyaluminum hydroxychlorosulfate calcium chloride, polyaluminum hydroxychlorosulfate calcium halide, polyaluminum hydroxyphosphate chloride, polyaluminum hydroxyphosphate halide, polyaluminum hydroxy “metal” chloride and/or sulfate and/or phosphate, polyaluminum “multi-metal” hydroxy chloride and/or sulfate and/or phosphate, polyaluminum hydroxy “metal” halide and/or sulfate and/or phosphate, polyaluminum “multi-metal” hydroxy halide and/or sulfate and/or phosphate and the like, wherein the “metal” is any metal that exists in the +2 or +3 valence state.

It has been shown possible by means of the instant invention to Obtain the above-mentioned MP(s), whereby the raw materials can simply be: a metal halide salt; along with the base metal in said MP in the form of bauxite, alumina, hydroxide, oxide or metal; water; and H₂SO₄ and/or H₂SO₃. The H₂SO₄ and/or H₂SO₃ are most preferably replaced with S and air or S and O₂. Moreover, recycled metal is a possibility. Metals, other than aluminum, can be used if prepared in their +2 or +3 valence state and in their respective acid, oxide or hydroxide form. As a recycling measure, waste catalyst streams from refineries and/or chemical plants containing aluminum halide or other metal halides can be used.

The instant invention manages hazardous materials, heat energy, chemical energy, electrical energy, as well as investments in equipment and raw material cost more effectively than the previous processes, which focused primarily on formation of the polynucleate aluminum compounds and/or disinfectants. In contrast, the instant invention focuses on the processes of MP production, incorporating methods to manage materials and energy not taught previously. Due to this management, the cost of manufacture of MP(s) and ACS, or any aluminum halide Solution (AHS) or metal halide solution (MAS), is much less than that previously. As additional process products, when the production of at least one selected from list comprising: SO₂, SO₃, H₂SO₃, H₂SO₄ and any combination therein is produced, the cost of manufacture of at least one selected from a list comprising: hypohalites, halites, halates, halogen oxides, O₂, O₃, H₂O₂ and any combination therein can be reduced significantly. While the hypohalites, halites, halates can be formed with any metal halide salt, the preferred metal is at least one selected from a list comprising: sodium, potassium and calcium with chloride or bromide the preferred halogen. The instant invention also significantly improves the handling of H₂O₂. By eliminating the cost and safety issues associated with the transportation and storage of H₂O₂, H₂O₂ can be a much safer and more economical oxidant and/or disinfectant. In addition, the instant invention significantly improves the cost of manufacture for H₂O₂, as well as O₂ and O₃. The instant invention provides a low cost energy source providing steam energy and/or electricity, thereby eliminating or significantly reducing the electrical cost for electrolysis of: H₂O into H₂ and O₂, H₂O into H₂ and H₂O₂ and O₂ into O₃. The same energy source provides a reduced cost energy source to cryogenically distill air for the production of O₂ and/or N₂.

In the instant invention, both the halide acid and its associated metal hydroxide or metal hydroxide may be produced from the metal/halide salt by electrolysis process in an EU. While sodium chloride is preferred, any metal halide salt solution may be used to form the associated halide acid and the associated metal hydroxide solution. However, the halide acid can be used and is more economically formed by the reaction of the metal halide salt with H₂SO₄ and/or H₂SO₃ in the SAP. This is more economically accomplished in SAP because of the available chemical energy from the reaction of a metal halide salt with H₂SO₄ and/or H₂SO₃; this exothermic reaction produces the halide acid, gas if anhydrous and acid solution if hydrous, along with the corresponding metal salt, wherein the anion for said salt is at least one selected from a list comprising: sulfite, bisulfite, sulfate and any combination therein.

A preferred embodiment utilizes aqueous sodium chloride in the EU as a metal halide salt, wherein the associated acid product is aqueous HCl and the associated caustic product is sodium hydroxide (NaOH). A most preferred process embodiment utilizes anhydrous or aqueous sodium chloride as a metal halide salt in the SAP, wherein the associated acid product is aqueous HCl and the associated byproduct salt is sodium sulfate, sulfite or bisulfite. A preferred process embodiment utilizes aqueous calcium chloride as the metal halide salt in EU, wherein the associated acid product is aqueous HCl and the associated caustic product is calcium hydroxide. A most preferred process embodiment utilizes anhydrous or aqueous calcium chloride as a metal halide salt in the SAP, wherein the associated acid product is aqueous HCl and the associated byproduct salt is calcium sulfate, sulfite or bisulfite.

A preferred process embodiment utilizes aqueous potassium chloride as a metal halide in the EU, wherein the associated acid product is aqueous HCl and the associated caustic product is potassium hydroxide. A preferred process embodiment utilizes aqueous potassium chloride as a metal halide in the SAP, wherein the associated acid product is aqueous HCl and the associated byproduct salt is potassium sulfate, sulfite or bisulfite.

As can be readily seen, the metal halide salt can easily be any metal in combination with any halide. It is preferred that the metal be at least one selected from a list comprising a: Group IA metal, Group IIA metal, Group IIIB metal, Group VIII metal, Group 1B metal, Group IIB metal, Group IIA metal and any combination therein. It is most preferred that the metal be at least one selected from a list comprising: sodium, calcium, potassium, magnesium, aluminum, copper and any combination therein.

An embodiment is to utilize any metal halide salt in the EU, wherein the associated acid product is the aqueous halide acid and the associated caustic product is the metal hydroxide. An embodiment is to utilize any halide salt in the SAP, wherein the associated acid product is halide acid, aqueous or dry, and the associated byproduct sulfate, sulfite or bisulfite salt is the associated metal sulfate, sulfite or bisulfite, respectively.

A most preferred embodiment is to use any metal halide salt in the EU, wherein the associated product is an oxygen containing oxidation product of the halide, such as a hypochlorite, chlorite or chlorate, wherein the chlorine can be replaced with another halogen, thereby represented by hypohalite, halite and halate, respectively. A preferred embodiment is to manufacture a halogen dioxide wherein the EU forms either a metal halite and/or a metal Halate and/or halide acid and wherein a halogen dioxide is formed via at least one of said manufactured: acid, halite, halate, H₂SO₄ and any combination therein, as is known in the art. A most preferred embodiment is to manufacture ClO₂, wherein the EU forms either sodium chlorite and/or sodium chlorate and wherein ClO₂ is formed via said manufactured chlorite and/or chlorate, as is known in the art. A most preferred embodiment is to manufacture ClO₂ with the EU, wherein the EU forms either sodium chlorite and/or sodium chlorate and HCl is formed by the SAP and wherein ClO₂ is formed via said manufactured chlorite and/or chlorate with said HCl manufactured by the SAP.

In the SAP, either the anhydrous salt or brine (at a concentration of up to the solubility limit of the metal halide salt) may be used. The anhydrous salt or brine is added to H₂SO₄ and/or H₂SO₃ to form the associated halide acid, which in the case of sodium chloride is HCl, and the associated byproduct salt, which in the case of sodium chloride is at lest one selected from a list comprising: sodium sulfate, sodium sulfite and sodium bisulfite. Aqueous condensation of the acid gas is preferred; the boiling point of anhydrous H₂SO₄, Na₂SO₄ and NaCl at atmospheric pressure is approximately 340, N.B. and 1413, ° C. respectively, while the boiling point of anhydrous HCl at atmospheric pressure is approximately −85° C., leaving separation of the byproduct metal salt from an anhydrous and/or aqueous halide acid rather easily performed. Distillation, or separation, of a resulting aqueous halide acid solution permits the capability of directly controlling the aqueous halide acid concentration by concentration of the salt in the brine and/or by addition of water to the acid condensation or distillation process. An embodiment is to perform reaction of a metal halide salt with hot H₂SO₄ and/or H₂SO₃, as said acid(s) contain heat from the H₂SO₄ and/or H₂SO₃ formation process, thereby providing said heat to vaporize the formed halide acid. A preferred embodiment to perform reaction of a metal halide salt with hot H₂SO₄ and/or H₂SO₃, as said acid(s) contain heat from the H₂SO₄ and/or H₂SO₃ formation process at a temperature of between about 0 and about 340° C., thereby providing said heat to vaporize the formed halide acid. A most preferred embodiment to perform reaction of a metal halide salt with hot H₂SO₄ and/or H₂SO₃, as said acid(s) contain heat from the H₂SO₄ and/or H₂SO₃ formation, wherein the temperature of said reaction is controlled by a water and/or steam jacket between about 0 and 300° C., thereby managing heat with the formation of a halide acid.

It is an embodiment to perform anhydrous and/or aqueous halide acid distillation under pressure and/or under vacuum conditions. It is preferred that the time/temperature relationship of the halide acid or halide acid solution be managed to minimize energy requirements while decomposing of any remaining halite ions to halide ions (approximately 60° C. is required). The resulting byproduct sulfate, sulfite and/or bisulfite salt can be easily separated being either a cake or in solution (depending on distillation and/or separation temperature and pressure). This byproduct may be improved by reacting with any caustic to a byproduct pH of near 7.0, thereby purifying the byproduct metal salt. It is most preferred that the byproduct metal salt be pH adjusted with NaOH. It is preferred that the byproduct metal salt be pH adjusted with a metal hydroxide, which most preferably corresponds to the metal in said byproduct metal salt. It is most preferred to dehydrate the byproduct metal salt to a powder for sale to the market. It is preferred to sell the byproduct salt as a cake. It is an embodiment to sell the byproduct salt in solution.

Significant economies can be obtained by the preparation of H₂SO₄ and/or H₂SO₃. While the market price of H₂SO₄ and H₂SO₃ is not lucrative and the business very competitive, the formation of H₂SO₄ and/or H₂SO₃ from S, air and H₂O or S, O₂ and H₂O is very exothermic. There are two processes known to manufacture H₂SO₄ and H₂SO₃, the condensation and the contact process; the contact process is preferred in this instant invention. The sulfuric acid contact process (SACP) produces H₂SO₄ and/or H₂SO₃ from S, H₂O and air or O₂ (with one stage of reaction requiring a catalyst, preferably vanadium oxide, V₂O₅). Every mole of anhydrous H₂SO₄ produced from S, H₂O, and air or O₂ also produces approximately 71,340 calories of energy. This valuable energy is preferably used to produce steam for at least one selected from a list comprising: the purification of bauxite, heating of the metal polymer reactor (MPR, which can used to manufacture PAC(s) as well as MP(s)), heating of an SAP reaction and/or SAP product distillation, reducing the H₂O content of by-product metal sulfate, sulfite or bisulfite salts with air evaporative dehydration, electricity generation to operate the EU and any combination therein. The SACP is summarized by:
2S (s)+3O₂ (g)+2H₂O→2H₂SO₄ (l)+142,679 cal
and can be understood in more detail by:
1) S+O₂→SO₂+70,944 cal.
   2) SO₂+O₂→SO₃+47,270 cal. (400° F. with catalyst, preferably V₂O₅)
   3) SO₃+H₂SO₄→H₂S₂O₇ (oleum); and
   4) H₂S₂O₇+H₂O→H₂SO₄+20,820 cal.
      (Contact of SO₃ with H₂SO₄ to form oleum can be eliminated; however, SO₃+H₂O→H₂SO₄ is a slow reaction.)

Sulfurous acid, H₂SO₃, is formed by reacting SO₂, from the first reaction, with H₂O.

Sodium sulfite is formed by reacting SO₂, from the first reaction, in an aqueous solution of sodium hydroxide; a metal sulfite is formed by reacting SO₂, from the first reaction, in an aqueous solution of said metal hydroxide or by reacting a metal sulfite with H₂SO₃.

Sodium bisulfite is formed by the reaction of SO₂, from the first reaction, in an aqueous solution of sodium carbonate; and a metal bisulfite is formed by the reaction of SO₂, from the first reaction, in an aqueous solution of said metal carbonate.

The purification of bauxite to alumina creates alumina for the preparation of aluminum halide solution (AHS), wherein ACS can be formed by reacting alumina with HCl. Purified bauxite, alumina, may also be required for MP production, in the MPR, if the raw bauxite contains any other heavy metal impurities and the resultant MP is to be used in drinking water purification or another application where heavy metal purity is an issue. In addition to the energy economics of H₂SO₄ and/or H₂SO₃ production, on-site production of H₂SO₄ and/or H₂SO₃ eliminates the transportation and storage of H₂SO₄ and/or H₂SO₃. As discussed previously, H₂SO₄ and/or H₂SO₃ are hazardous chemicals that must be stored in the appropriate tankage, wherein the vapors must be controlled. Therefore, it is preferred that H₂SO₄ and/or H₂SO₃ produced for the SAP have minimal volume storage. It is a most preferred embodiment to produce H₂SO₄ and/or H₂SO₃ from the SACP and therein directly react said “hot” H₂SO₄ and/or H₂SO₃ with a metal halide in the SAP, thereby utilizing the H₂SO₄ and/or H₂SO₃ energy to distill the halide acid.

It is preferred to produce with an EU at least one selected from a list comprising: hypohalites, halites and halates, O₂, O₃, H₂, H₂O₂ and any combination therein, wherein at least a portion of the electrical energy in the EU is obtained from the energy of formation of at least one selected from a list comprising: SO₂, SO₃, H₂SO₃, H₂SO₄ and any combination therein. It is preferred to produce with an EU at least one selected from a list comprising: hypohalites, halites and halates, O₂, O₃, H₂, H₂O₂ and any combination therein, wherein at least a portion of the electrical energy in the EU is obtained from the energy of combustion and/or of fuel cell conversion of said produced H₂.

If the EU is used to produce halide acids, the halide acid from the EU is preferably heated: immediately after the EU, within the EU, during AHS formation, during Metal Acid Solution (MAS) formation or a combination therein so that the chlorite ions are decomposed into chloride ions while utilizing the enthalpy from at least one selected from: electrolysis, AHS formation, MAS formation and any combination therein to minimize heating expense.

It is most preferred to produce at least one selected form a list comprising calcium, sodium and potassium hypochlorite, chlorite and chlorate, wherein at least a portion of the electrical energy for the EU is obtained from steam energy, wherein said stem energy is obtained from the energy of formation of at least one selected from a list comprising: SO₂, SO₃, H₂SO₃, H₂SO₄ and any combination therein. It is preferred that halide acid production, from either the EU or the SAP be employed in the EU for the production of the associated halide gas, halide acid, hypohalite, halite or halate. It is preferred that the brine used in the EU to manufacture a hypohalite, halite or halite be a waste brine solution or be a waste material for recycling purposes. Of all the available metal halides to be used in the EU and the SAP, sodium, potassium and calcium are preferred cations and chlorine and bromine are the preferred anions.

Metal hydroxides, while a potential by-product of the EU are a preferred material to be used in at least one selected from a list comprising: the preparation of alumina, the production of hypohalites, the production of halites, the production of halates, the production of halogen dioxide, the scrubbing of halide acid gases released during this process, pH control applications that include those in the water treatment industry and pH polishing of the by-product metal sulfate, sulfite or bisulfite salt formed in the SAP.

H₂O₂ can be produced utilizing H₂SO₄ as the catalyst. In this reaction, H₂O₂ is formed in a two stage process, wherein the first stage H₂S₂O₈ and H₂ are formed by electrolysis from H₂SO₄. In the second stage, the H₂S₂O₈ from the first stage is reacted with H₂O to form H₂O₂ and H₂SO₄. The H₂ gas can be: vented, stored or used as an energy source; the H₂SO₄ can be recycled for additional production of H₂S₂O₈ and H₂. The use of H₂O₂ in water treatment and other applications has been limited due to its explosive nature creating expense in both transportation and in storage; H₂O₂ is a much more hazardous chemical than is H₂SO₄ and/or H₂SO₃ to store and transport. It is most preferred to produce H₂O₂ utilizing H₂SO₄ from the SACP. It is preferred to produce H₂O₂ and H₂ wherein, at least a portion of the electrical energy for the electrolysis of H₂O to H₂O₂ is obtained from the energy of formation of at least one selected from a list comprising: SO₂, SO₃, H₂SO₃, H₂SO₄ and any combination therein. It is preferred to recycle at least a portion of the H₂ from H₂O₂ electrolysis manufacture wherein, at least a portion of the electrical energy for the electrolysis of H₂O to H₂O₂ is obtained from the energy of combustion and/or of fuel cell conversion of said H₂.

O₂ is preferably produced via at least one selected from a list comprising: cryogenic distillation of air, membrane separation of air, PSA separation of air and any combination therein; all of these process and process combinations are herein referred to as air separation processes (ASP). It is preferred to produce steam energy from the energy of formation of at least one selected from a list comprising: SO₂, SO₃, H₂SO₃, H₂SO₄ and any combination therein, wherein said steam energy powers one of said ASP. It is preferred that said energy of formation be converted to steam and that said steam powers said ASP via a steam engine, as is known in the art. It is preferred that said energy of formation be converted to steam energy, wherein said steam energy be converted to electricity via a steam turbine (turned by said steam), as is known in the art, wherein said electricity powers said ASP. It is preferred that said ASP be as is known in the art. It is preferred that said electricity be used to power an electrolysis unit to convert O₂ into O₃.

It is preferred to provide steam to a portion of the metal hydroxide solution in order to perform the “Bayer” Refining Process (BRP), which can preferably proceed adjacent to the EU, thereby utilizing the enthalpy of electrolysis to minimize steam required in the BRP. While the BRP is most preferably used to purify bauxite, an alternate preferred method would be to utilize recycled aluminum metal, where the metal is purified in the BRP alone or with bauxite. If recycled aluminum is used, a portion of the halide acid production can be used to assist in the purification of the recycled aluminum or converting the aluminum to the associated aluminum halide acid, which is preferably ACS. A side stream of the hydroxide solution is preferably available to the MPR to assist in managing either the reactor pH or final MP basicity, as needed. Portions of the metal hydroxide solution are preferably sent to the halide acid gas scrubbing system to pH neutralize the liquid effluent and/or to the by-product metal stream to pH the final by-product metal sulfate, sulfite or bisulfite salt.

The MPR is preferably adjacent or near the EU and/or the BRP so that the enthalpy of alumina formation can be utilized in the formation of MP(s). The MPR can be a continuous stirred tank reactor (CSTR) or a pipe reactor, otherwise known as a plug flow reactor (PFR). It is most preferred that the MPR have high shear mixing, as the instant invention has found high shear conditions during aqueous formation of MP(s) to be a significant asset in polynucleate formation and the minimization of waste-product, gel, formation. It is preferred that a vent scrubber be placed on the reactor to control halide acid gas emissions. The MPR may be equipped to operate at elevated temperature, pressure or both to form MP(s). It is preferred that the MPR be operated at approximately 110-150° C.; however, depending on the final product composition, the MPR can be operated between approximately 30-200° C. While higher temperatures allow for an increase in the reaction rate constant for MP formation, increases in MPR operating temperature require a corresponding increase in the operating pressure to maintain reactants in an aqueous solution (H₂O, Al, OH, Cl, etc.) Reactor pressure can be 1 to 7 atmospheres absolute, wherein 1.5 to 4 atmospheres is preferred.

Much improved results are achieved in tests with higher mixing energies, thereby creating a high shear situation in the MPR so as to minimize gel formation. It is most preferred that reactor mixing energy create a shear situation of approximately greater than 30 sec⁻¹. However, as is known in the art of mixing, a high shear mixing scenario can be created by many means, including a: centrifugal pump, homogenizer, reactor agitator or any physical system which combines the aqueous reactants in a situation of high kinetic energy contact. High shear mixing energies are required to minimize waste product, gel, formation and maximize final MP formation. It has further been found in the instant invention that high shear mixing energies lengthen the shelf life of the MP by as much as 100 to 500 percent. It is theorized that this increase is obtained due to a minimization on an atomic scale, of gel and a minimization of available sites for gel to begin formation over time.

The aluminum (A) halogen (H) reactor (R), (AHR), or metal acid reactor (MAR), is also preferably placed near or adjacent to the EU and/or the SAP and preferably adjacent to the MPR so that the enthalpy of reaction to form MAS, AHS or similar can be utilized in the MPR. MAS is formed from the aqueous reaction of a halide acid with a metal, metal salt, metal oxide or metal hydroxide, wherein reaction with a metal, metal oxide and metal hydroxide preferred. AHS is formed from the reaction of the halide acid with at least one selected from a list comprising: bauxite, an aluminum salt, aluminum, aluminum oxide and aluminum hydroxide. The AHR or MAR can be either a CSTR or a PFR. A vent scrubber is preferably to be placed on said reactor or downstream of said reactor to control emissions of HClg, or other halogen gas if a halogen acid other than HCl is used. A portion of the enthalpy form AHS or MAS manufacture can be utilized to decompose halite ions. The concentration of aluminum in the AHS or of metal(s) in the MAS is preferably controlled by water dilution to at least one of the AHR, MAR, EU or SAP. AHS containing up to 5 percent aluminum can easily be prepared in the AHR for the MPR. MAS can be prepared in the MAR for the MPR by reaction of the halide acid with the appropriate metal, metal salt, metal oxide or metal hydroxide. AHS and MAS are easily prepared with the appropriate halide acid reacting with the chosen metal, metal salt, metal oxide or metal hydroxide. It is a preferred embodiment that the AHR and MAR be the same equipment. It is a preferred embodiment that the AHR and MPR be the same equipment. It is a preferred embodiment that the MAR and MPR be the same equipment. It is a preferred embodiment that the AHR, MAR and MPR be the same equipment.

Aluminum is provided with at least one selected from a list comprising: bauxite, alumina, aluminum hydroxide, aluminum metal and any combination therein. The aluminum metal can be refined or recycled. Should bauxite be used and NaOH or MOH from the EU be provided to refine the bauxite, the waste minerals from bauxite refining have many market uses, such as soils stabilization. It is most preferred to use alumina, aluminum or purified recycled aluminum in the preparation of AHS and MP because the acidification of bauxite, aluminum, aluminum oxides and aluminum hydroxides to AHS can also acidify any other metal impurities that may be present in recycled aluminum or bauxite, thereby allowing said metal impurities to react within the AHS and/or the final MP. In cases wherein heavy metal contamination is not an issue and/or the bauxite is pure enough from other earthen contaminants, both AHS and MP can be formed utilizing the raw bauxite. Any metal oxides that do not enter the MP complex can be used for soil stabilization.

It is an embodiment to react metal(s) other than aluminum into the MP; said metal(s) are to be preferably acidified in the MAR prior to addition to the MPR. When any metal other than aluminum is reacted in the MP, that or those metals need to: form either a +2 or +3 valence state in the MAS, be prepared in their respective oxide or hydroxide form in either the +2 or +3 valence state prior to addition to the MPR or be capable of entering a +2 or +3 valence state in the MPR. While more than one metal other than aluminum can be entered into the MP and an MP can be manufactured with at least one metal other than aluminum, wherein no aluminum is used, in this instant invention it is preferred to maximize the use of aluminum and minimize the use of other metals due to the availability and cost of bauxite, alumina and aluminum. For particular applications, it may be preferred to choose a metal for that particular application; examples would include zirconium for antiperspirants, copper for algae control in water systems, tin as a sacrificial metal in corrosion control applications and gold or silver for conductivity applications. MAS is therefore defined herein as at least one metal in halide acid solution wherein said metal(s) are in the +2 or +3 valence state in concert with at least one halogen in anionic form.

A final MP product is prepared having an aluminum content of approximately 3-12 percent. A solid MP can be obtained by drying, wherein a product containing approximately 12-24 percent of aluminum is obtainable, whereby spray drying or rolling can be used as the drying method. A product containing aluminum and another metal(s) can be obtained, wherein the combined aluminum/other metal(s) concentration is less than or equal to approximately 12 percent if in solution or approximately equal to or less than 24 percent if dried. A product containing at least one metal other than aluminum can be obtained, wherein the metal(s) concentration is less than or equal to approximately 12 percent if in solution or approximately equal to or less than 24 percent if dried.

There is no need to use an excess of aluminum or metal in the MPR, as with high shear mixing, the reaction has demonstrated near completion. As is known in the art, a higher molar relationship can easily be increased by adding CaO, CaCO³ or Ca(OH)₂ whereby a molar relationship of 1.8-1.9 can be obtained without increasing the reaction time to any considerable extent. In the case that one should want a further increase in the molar relationship OH:Al or OH:metal up to 2.5, metallic aluminum or metallic metal is to be added in the stoichiometric amount.

It is most preferred to manufacture at least one of: MP(s), AHS(s), hypohalites, halites, halates and halogen oxides without vehicular transportation of hazardous materials, which would include at least one selected from a list comprising: metal acid solution, halide acid solution, sulfuric acid and caustic.

Heat energy, enthalpy, will be created from the process of electrolysis, halogen acid formation and AHS or MAS formation. Energy will be required for bauxite purification to alumina, if bauxite is used and needs to be purified. Energy will be required for MP formation in the MPR. Energy will be required for recycled aluminum purification, if employed. Depending on production rates and the type of raw materials utilized, energy can be easily transferred form one reaction vessel to another (via heat transfer in the form of the product itself, vessel water jacketing and vessel steam jacketing) so that there is maximal efficiency in the use of enthalpy from chemical reaction and from steam. For example, if larger quantities of AHS or MAS were required than could be used to provide heat for halite decomposition or to heat the MPR for MP production or to heat the Bayer Process for bauxite purification. For example, waste steam or low pressure steam can be used to heat sulfur to a molten state for ease of handling in and to the SACP.

A preferred embodiment of the instant invention is to form within a manufacturing plant, manufacturing process systems and flow paths. It is a preferred embodiment to form at least one process flow path, wherein steam energy is created by heat transfer from the energy of formation of at least one selected from a list comprising: SO₂, SO₃, HSO₃, H₂SO₄ and ay combination therein.

It is preferred to form a process flow path, wherein a unit or units comprising an MPR (which includes both polynucleate aluminum manufacture and polynucleate metal manufacture) is downstream of a unit or units comprising a MHR, and wherein said MHR forming ACS and/or MAS is downstream of a unit or units forming a halide acid, wherein said unit or units forming said halide acid can be at least one of an EU and an SAP. It is preferred to form a process flow path, wherein a unit or units comprising an MPR is downstream of a unit or units comprising a MHR, and wherein said MHR forming ACS and/or MAS is downstream of a unit or units forming a halide acid, wherein said unit or units forming said halide acid can be at least one of an EU and an SAP, and wherein the H₂SO₃ and/or H₂SO₄ for said SAP is manufactured in a unit or units comprising an SACP and/or the electricity for said EU is generated in a steam turbine, and wherein the steam energy used in said steam turbine is obtained from the formation of at least one selected from a list comprising: SO₂, SO₃, HSO₃, H₂SO₄ and ay combination therein. It is preferred for the MPR, and MAS (which includes the AHR) unit(s) to be one and the same.

It is a preferred embodiment to form a process flow path, wherein a unit or units form a disinfectant and/or an oxidant in an EU, wherein the electricity for said EU is obtained from a steam turbine, wherein the steam energy used in said steam turbine to create said electricity is from H₂SO₃ and/or H₂SO₄ manufacture in an SACP, wherein said SACP is upstream of said EU. It is a preferred embodiment to form a process flow path, wherein a unit or units form a disinfectant and/or an oxidant in an EU, wherein the electricity of electrolysis for said EU is created in a steam turbine, and wherein the steam energy used in said steam turbine is at least partially obtained from the formation of at least one selected from a list comprising: SO₂, SO₃, H₂SO₃, H₂SO₄ and any combination therein, and wherein said formation is upstream of an EU and/or an SAP. It is a most preferred embodiment that an EU and an SAP form a process flow path, wherein disinfectants are formed in an EU and halide acids are formed in an SAP, which can be used to form disinfectants in a unit or units downstream of said EU.

It is a preferred embodiment to form a process flow path, wherein a unit or units perform ASP, thereby producing O₂ and N₂, wherein said ASP is powered by electricity and/or torque, wherein said electricity and/or torque is produced from steam, and wherein said steam is converted energy from H₂SO₃ and/or H₂SO₄ manufacture in an SACP. It is a preferred embodiment to form a process flow path, wherein a unit or units perform ASP, thereby producing O₂ and N₂, wherein said ASP is powered by electricity and/or torque, wherein said electricity and/or torque is produced from steam, and wherein said steam is converted energy from the formation of at least one selected from a list comprising: SO₂, SO₃, H₂SO₃, H₂SO₄ and any combination therein.

It is a preferred embodiment to form a process flow path, wherein a unit or units electrolyze O₂ to O₃, and wherein said O₂ is obtained from an ASP, thereby producing O₂ and N₂, wherein said ASP is powered by electricity and/or torque, and wherein the electrolysis of O₂ is powered by electricity, wherein said electricity and/or torque is produced from steam energy, and wherein said steam energy is converted energy from H₂SO₃ and/or H₂SO₄ manufacture in an SACP. It is a preferred embodiment to form a process flow path, wherein a unit or units electrolyze O₂ to O₃, and wherein said O₂ is obtained from an ASP, thereby producing O₂ and N₂, wherein said ASP is powered by electricity and/or torque, and wherein the electrolysis of O₂ is powered by electricity, wherein said electricity and/or torque is produced from steam energy, and wherein said steam energy is converted energy from the formation of at least one selected from a list comprising: SO₂, SO₃, H₂SO₃, H₂SO₄ and any combination therein.

It is a preferred embodiment to form a process flow path, wherein a unit or units electrolyze O₂ to O₃, and wherein said O₂ is obtained from electrolysis of H₂O, thereby producing O₂ and H₂, wherein the electricity for said electrolysis is produced by a steam turbine, wherein said steam turbine is turned by steam energy obtained from heat energy released by the manufacture of H₂SO₃ and/or H₂SO₄ in an SACP. It is a preferred embodiment to form a process flow path, wherein a unit or units electrolyze O₂ to O₃, and wherein said O₃ is obtained from electrolysis of O₂, wherein the electricity for said electrolysis is produced from steam energy in a steam turbine, and wherein said steam energy is obtained from the formation energy of at least one selected from a list comprising: SO₂, SO₃, H₂SO₃, H₂SO₄ and any combination therein.

It is a preferred embodiment to form a process flow path, wherein a unit or units electrolyze H₂O₂ from H₂O, and wherein H₂SO₄ is used as a catalyst and the energy of electrolysis for H₂O₂ manufacture is converted energy from the formation of at least one from a list comprising: SO₂, SO₃, HSO₃, H₂SO₄ and ay combination therein. It is a preferred embodiment to form a process flow path, wherein a unit or units electrolyze H₂O₂ from H₂O, and wherein H₂SO₄ is used as a catalyst, and wherein the energy of electrolysis is converted steam energy in a steam turbine, and wherein said steam energy is obtained from the formation of at least one selected from a list comprising: SO₂, SO₃, HSO₃, H₂SO₄ and ay combination therein.

It is a preferred embodiment to form a process flow path, wherein a unit or units recycle the H₂ byproduct from electrolysis as an energy source to make electricity, wherein said electricity is generated in either a combustion engine and/or a fuel cell. It is a preferred embodiment to utilize at least a portion of said electricity in the EU to manufacture disinfectants and/or oxidants. It is preferred to convert steam energy into electricity with a steam turbine, as is known in the art.

Bench scale tests reacting ACS in solution with aluminum hydroxide at a temperature of 110-140° C. for 1.5 to 5 hours, whereby the reaction of Al_{X}Cl_{Y}(OH)_{Z} is formed have been performed. The formation of ACS from aluminum metal was performed in one case and aluminum hydroxide was performed in the second case. In both cases, HCl was formed by the reaction of chlorine gas into water, where the water solution was heated continuously to 60° C. for 15 minutes to assure complete chloride formation. In the third test, a portion of the aluminum hydroxide was replaced with MgO forming Al_{X}Mg_{W}Cl_{Y}(OH)_{Z}. In a fourth test, a portion of the ACS was replaced with MgCl2 again forming Al_{X}Cl_{Y}(OH)_{Z}. In a fifth test, a portion of the aluminum hydroxide was replaced with lime, CaO, forming Al_{X}Ca_{W}Cl_{Y}(OH)_{Z}. In a sixth test, sulfuric acid was added to the ACS forming Al_{X}Mg_{W}Cl_{Y}(OH)_{Z}(SO₄)_{V}. In a seventh and poor performing test, a portion of the ACS was replaced with ferric chloride. In an eighth test, a portion of the aluminum was replaced with copper forming Al_{X}Cu_{W}Cl_{Y}(OH)_{Z}; this rather green product revealed a shelf life of over 2.5 years before forming a precipitate. In test nine, the ACS was replaced with a waste catalyst stream form Dow Chemical containing ACS. Test ten was a filed coagulation test of the final MP made in Example “8.” In an eleventh test, an MAS was prepared by dissolving CuCl₃ in water, which was then reacted with MgO. In all cases, the relationship OH:Al or OH:metal in the resulting compound became 0.5 to 1.5; where, this relationship is preferably greater than 1.2. In all cases the pH of the final solution was between 4.0 and 5.0. In all cases, improved results were obtained with high shear mixing as compared to low. It was found that at high shear mixing energies, a greater proportion of the aluminum went into the MP and the tendency to form a gelatinous precipitate was reduced.

In test twelve, salts were reacted with concentrated sulfuric acid. While ammonium is not a metal, a test was performed with ammonium chloride since the ammonium cation has “metal-like” qualities in salt formation. Even though the ammonium cation is not the most practical “metal-like” cation, given the results, the term “metal” in metal halides is to include “metal-like” moieties, preferably the ammonium cation. The test results are reviewed below:

### EXAMPLE 1

Chlorine gas is slowly bubbled into a 1-L beaker until the Sg of the aqueous solution is approximately 1.08 to 1.1. The acidic solution is continuously stirred and heated to 60° C. for 15 minutes; after which, 50 grams of aluminum metal are dissolved into solution while slowly stirring for 15 minutes to prepare the ACS. 300 ml of this ACS having an aluminum content of approximately 5% is then heated to 120° C. and stirred vigorously while slowly adding 30 gm of Al(OH)₃ powder. The system is kept at 120° C. and stirred vigorously for 3 hours, after which all of the powder is noted to have gone into solution. The liquid was allowed to cool. The final product was a cloudy liquid having an aluminum content of approximately 10%.

### EXAMPLE 2

Chlorine gas is slowly bubbled into a 1-L beaker until the Sg of the aqueous solution is approximately 1.08 to 1.1. The acidic solution is continuously stirred and heated to 60° C. for 15 minutes; after which 100 grams of Al(OH)₃ powder is dissolved into solution while slowly stirring for 165 minutes to prepare the ACS. 300 ml of this ACS having an aluminum content of approximately 5 percent is then heated to 130° C. and stirred vigorously while slowly adding 30 gm of Al(OH)₃ powder. The system is kept at 130° C. and stirred vigorously for 3 hours, after which all of the powder is noted to have gone into solution. The liquid was allowed to cool. The final product was a cloudy liquid having an aluminum content of approximately 10 percent.

### EXAMPLE 3

An ACS from Gulbrandsen Technologies, GC 2200, was utilized for the ACS. This sample of GC 2200 measured 10.1 percent Al₂O₃ having a Sg of 1.28 and due to the yellow color had a small amount of iron contamination. To an autoclave, provided with a stirrer, 300 ml of the ACS were added along with 5 gm of MgO from Premiere Services and 25 gm of laboratory grade Al(OH)₃ powder. The mixture was heated to 120° C. and stirred vigorously for five hours. The liquid was allowed to cool. The final product was clear having an aluminum content of approximately 6 percent and a magnesium content of approximately 2 percent.

### EXAMPLE 4

An ACS from Gulbrandsen Technologies, GC 2200, was utilized for the ACS. This sample of GC 2200 measured 10.1 percent Al₂O₃ having a Sg of 1.28 and due to the yellow color had a small amount of iron contamination. To a 2-L beaker, 300 ml of the ACS were added along with 10 gm of MgCl₂×6H₂O crystals and 25 gm of laboratory grade Al(OH)₃ powder. The mixture was heated to 110° C. and stirred vigorously for four hours. The liquid was allowed to cool. The final product was clear having an aluminum content of approximately 10 percent and a magnesium content of approximately 2 percent.

### EXAMPLE 5

An ACS from Gulbrandsen Technologies, GC 2200, was utilized for the ACS. This sample of GC 2200 measured 10.1 percent Al₂O₃ having a Sg of 1.28 and due to the yellow color had a small amount of iron contamination. To an autoclave, 300 ml of the ACS were added along with 10 gm of CaO and 20 gm of laboratory grade Al(OH)₃ powder. The mixture was heated to 100° C. and stirred vigorously for four hours. The liquid was allowed to cool. The final product was cloudy having an aluminum content of approximately 7 percent and a calcium content of approximately 3 percent.

### EXAMPLE 6

An ACS from Gulbrandsen Technologies, GC 2200, was utilized for the ACS. This sample of GC 2200 measured 10.1 percent Al₂O₃ having a Sg of 1.28 and due to the yellow color had a small amount of iron contamination. To an n autoclave, 300 ml of the ACS were added along with 10 ml of concentrated sulfuric acid and 10 gm of laboratory grade Al(OH)₃ powder. The mixture was heated to 140° C. and 25 psig stirring vigorously for four hours. The liquid was allowed to cool. The final product was clear having an aluminum content of approximately 6 percent.

### EXAMPLE 7

An ACS from Gulbrandsen Technologies, GC 2200, was utilized for the ACS. This sample of GC 2200 measured 10.1 percent Al₂O₃ having a Sg of 1.28 and due to the yellow color had a small amount of iron contamination. To an autoclave, 300 ml of the ACS were added along with 30 gm of alum and 10 gm of laboratory grade Al(OH)₃ powder. The mixture was heated to 140° C. and 25 psig and turned gelatinous.

### EXAMPLE 8

An ACS from Gulbrandsen Technologies, GC 2200, was utilized for the ACS. This sample of GC 2200 measured 10.1 percent Al₂O₃ having a Sg of 1.28 and due to the yellow color had a small amount of iron contamination. To a 2-L beaker, 300 ml of the ACS were added along with 10 gm of CuCl₂×6H₂O crystals and 25 gm of laboratory grade Al(OH)₃ powder. The mixture was heated to 100° C. and stirred vigorously for four hours. The liquid was allowed to cool. The final product was clear with a greenish tint having an aluminum content of approximately 8 percent and a copper content of approximately 2 percent.

### EXAMPLE 9

A waste catalyst from Dow Chemical (Freeport, Tex.) containing ACS was utilized for the ACS. The sample measured 18 percent Al₂O₃ having a Sg of 1.3; due to the greenish color the sample had a small amount of organic contamination. To a 2-L beaker, 300 ml of the ACS were added along with 35 gm of laboratory grade Al(OH)₃ powder. The mixture was heated to 105° C. and stirred vigorously for four hours. The liquid was allowed to cool. The final product was clear with a greenish tint having an aluminum content of approximately 10 percent.

### EXAMPLE 10

At the time of this test, the city of Marshall, Tex. was in drinking water production using CV 1703 as the coagulant. CV 1703 is a blend that is by volume: 38% CV 1120, 42% CV 1130, 8% CV 3210 and 12% CV 3650. CV 1120 is an ACH measuring 23% Al₂O₃ at 84% basicity, CV 1130 is an ACS that measures 10% Al₂O₃, CV 3210 is a 50% active Epi-DMA solution that measures 100+/−20 cps, and CV 3650 is a 20% active diallyl dimethyl ammonium chloride polymer that measures 2000+/−200 cps. Prior to using CV 1703, Marshall utilized CV 3650 in concert with alum. Alum was, at that previous time, used at 30 to 35 ppm along with CV 3650 at 1.5 ppm.

Marshall's raw water quality makes water purification difficult:
The raw alkalinity is less than 20 ppm and often as low as 6 ppm,
The raw turbidity is normally 2 to 7 NTU and infrequently 10 to 15 NTU,
The raw color varies from 20 to 400 Apparent Color Units (ACU), and
The raw TOC ranges form 5 to 20 ppm, with a UV absorbancy of 0.2 to 0.7 m⁻¹.

Prior to the use of CV 3650 with alum, Marshall operated with just alum and often went out of US EPA and Texas State permit having a final water turbidity of greater than 0.5 NTU; on Alum operation, Marshall frequently measured in excess of 0.20 mg/L of aluminum in the final drinking water. While CV 3650 significantly improved operations with alum, raw water color values of over 200 ACU required the use of CV 1703.

Prior to using CV 1703, Marshall produced filtered water at a turbidity of near 0.15 to 0.30 NTU under normal operating conditions and higher when the raw water color was a challenge. During operation with CV 1703, Marshall has had the ability to keep the filtered water turbidity under 0.08 NTU under all operating conditions with the settled water turbidity varying from 0.4 to 0.7 NTU. Per US EPA guidelines, Marshall must remove, at times 45% of the raw water TOC and, at times, 50% of the raw water TOC. During the year 2000, when the raw water has a lower organic content and nearly all of the raw TOC measures DOC per the standard industry test, Marshall is frequently unable to obtain 45% TOC removal. Operation during this time did not produce any final filtered water that had an aluminum concentration of over 0.20 mg/L.

On Dec. 15, 1999, the MP made in Example 8 was jar tested in comparison to CV 1120 and CV 1703. On that day the raw: color measured 55, NTU measured 4.1 and UV measured 0.185 m⁻¹. At 15 ppm, CV 1703 obtained a settled turbidity of 0.96 NTU, 14 ACU and 0.071 m⁻¹. At 15 ppm, the MP from Example 8 obtained a settled turbidity of 0.69 NTU, 11 ACU and 0.074 m^{-1.}

### EXAMPLE 11

To a 2-L beaker, 250 ml of water was added prior to 50 gm of CuCl₂×6H₂O crystals; the solution was pH adjusted to 1.0 with HCl. The resulting solution was then mixed with and 30 gm of MgO powder. The mixture was heated to 100° C. and stirred vigorously for four hours. The liquid was allowed to cool. The final product was clear with a greenish tint having a copper content of approximately 5 percent and a magnesium content of approximately 5 percent.

### EXAMPLE 12

Five salt compositions are reacted with concentrated sulfuric acid to test the efficacy of halide acid formation and sulfate/bisulfite formation.

In the first test, 4 gm of normal table salt (sodium chloride) is placed in a beaker containing 2 g of concentrated sulfuric acid. In this test a rather violent reaction takes place, wherein HCl gas is obviously released due to the tell tale chlorine odor; in the bottom of the beaker a solid precipitate forms which is obviously sodium sulfate.

In the second test, 4 gm of ammonium chloride is placed into a beaker containing 2 gm of concentrated sulfuric acid. In this test a rather violent reaction takes place, wherein HCl gas is obviously released due to the tell tale chlorine odor; in the bottom of the beaker a solid precipitate forms which is obviously the ammonium sulfate salt.

In the third test, 4 gm of CuCl₃×6H₂O crystals are placed into a beaker containing 2 gm of concentrated sulfuric acid. In this test an aggressive reaction takes place, wherein HCl gas is obviously released due to the tell tale chlorine odor; in the bottom of the beaker a solid precipitate forms which is obviously copper sulfate.

In the fourth test, 4 gm of AlCl₃×6H₂O crystals are placed into a beaker containing 2 gm of concentrated sulfuric acid. In this test an aggressive reaction takes place, wherein HCl gas is obviously released due to the tell tale chlorine odor; in the bottom of the beaker a solid precipitate forms which is obviously aluminum sulfate.

In the fifth test, 4 gm of MgCl₃×6H₂O crystals are placed into a beaker containing 2 gm of concentrated sulfuric acid. In this test an aggressive reaction takes place, wherein HCl gas is obviously released due to the tell tale chlorine odor; in the bottom of the beaker a solid precipitate forms which is obviously magnesium sulfate.

Certain objects are set forth above and made apparent form the foregoing description. However, since certain changes may be made in the above description without departing from the scope of the invention, it is intended that all matters contained in the foregoing description shall be interpreted as illustrative only of the principles of the invention an not in a limiting sense. With respect to the above description, it is to be realized that any descriptions, drawings and examples deemed readily apparent and obvious to one of skill in the art and all equivalent relationships to those described in the specification are intended to be encompassed by the instant invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention. It is also to be understood that the following claims are intended to cover all of the generic and specific features of the invention herein described, and all statements of the scope of the invention, which, as a matter of language, might be said to fall in between.

1. A method for the preparation of polynucleate aluminum compounds having the general formula Al_{X}(OH)_{Y}H_{Z}, wherein H is a halogen and wherein
said polynucleate aluminum compounds are formed by an aqueous reaction of an aluminum halide solution with at least one selected from a list comprising: bauxite, alumina, aluminum hydroxide, aluminum metal and any combination therein, and wherein
said aqueous aluminum halide solution is formed from the reaction of a halide acid with at least one selected from a list comprising: bauxite, alumina, aluminum hydroxide, aluminum metal and any combination therein, and wherein
said halide acid is formed by the reaction of a metal salt of said halide in an electrolysis unit and/or the reaction of a salt of said metal with H₂SO₄ and/or H₂SO₃.

2. A method for the preparation of polynucleate metal compounds having the general formula M_{X}(OH)_{Y}H_{Z}, wherein H is a halogen and wherein M is at least one metal in either the +2 or the +3 valence state, wherein
at least one of a metal halide solution and an aqueous aluminum halide solution is reacted with at least one selected from a list comprising: bauxite, alumina, aluminum hydroxide, aluminum metal, a metal other than aluminum in the +2 or +3 valence state, a metal other than aluminum in the 0 valence state and capable of entering the +2 or +3 valence state and any combination therein, and wherein
said aqueous aluminum halide solution is formed from the reaction of a halide acid solution with at least one selected from a list comprising: bauxite, alumina, aluminum hydroxide, aluminum metal and any combination therein, and wherein
said metal halide solution is formed from the reaction of a halide acid with at least one metal other than aluminum, wherein each metal other than aluminum in the metal halide solution is capable of entering the +2 or +3 valence state upon reaction with said halide acid, and wherein
said halide acid is formed by the reaction of a metal salt of said halide in an electrolysis unit and/or the reaction of a metal salt of said halide with H₂SO₄ and/or H₂SO₃.

3. A method for the preparation of a disinfectant, wherein said disinfectant comprises a halogen in the form of at least one selected from a list comprising a: halide acid, hypohalite, halite, halate, halogen oxide and any combination therein, and wherein
said disinfectant is manufactured by electrolysis of said halogen in solution with a metal, and wherein
the electricity for said electrolysis is generated in a steam turbine, and wherein
the steam energy for said steam turbine is created from the energy of formation of at least one selected from a list comprising: SO₂ from S and air or O₂; SO₃ from SO₂ and air or O₂; H₂SO₃ from SO₂ and H₂O; H₂SO₄ from SO₃ and H₂O; H₂SO₄ from SO₃, H₂SO₄ and H₂O; and any combination therein.

4. The method of claim 1 or 2, wherein said aluminum halide solution is a waste catalyst regardless of formation.

5. The method of claim 1, 2 or 3, wherein said metal halide solution is a waste brine regardless of formation.

6. The method of claim 1, 2 or 3, wherein said metal halide is a waste catalyst regardless of formation.

7. The method of claim 1, 2 or 3, wherein at least a portion of the energy of formation of at least one selected from a list comprising: SO₂ from S and air or O₂; SO₃ from SO₂ and air or O₂; said H₂SO₃ from SO₂ and H₂O; said H₂SO₄ from SO₃ and H₂O; said H₂SO₄ from SO₃, H₂SO₄ and H₂O; and any combination therein is used to generate steam.

8. The method of claim 7, wherein at least a portion of said steam is used to perform at least one selected from a list comprising: refine bauxite to alumina, heat a polynucleate metal compound reactor, evaporate H₂O from a metal salt solution and/or cake, degrade a halite to a halide, heat S, produce electricity and any combination therein.

9. The method of claim 7, wherein said steam is at least partially used to power an air separation unit, and wherein said air separation unit produces O₂.

10. The method of claim 8, wherein said electricity is at least partially used in electrolysis to form of at least one selected from a list comprising: O₂, O₃, H₂, H₂O₂, a halide acid, a hypohalite, a halite, a halate, a hydroxide and any combination therein.

11. The method of claim 8, wherein said electricity is at least partially used to power an air separation unit, and wherein said air separation unit produces O₂.

12. The method of claim 10, wherein said H₂ is at least partially used in a combustion engine turning a generator to make said electricity and/or in a fuel cell to make said electricity.

13. The method of claim 3, wherein said disinfectant is at least one of: O₂, O₃ and H₂O₂.

14. The method of claims 1, 2 or 3, wherein H₂ is produced in said electrolysis.

15. The method of claim 14, wherein said H₂ is at least partially used in a combustion engine turning a generator to make said electricity and/or in a fuel cell to make said electricity for said electrolysis.

16. The method of claim 13, wherein said H₂SO₄ is used as a catalyst in the formation of said H₂O₂.

17. The method of claim 1 or 2, wherein the energy from the formation of a halide acid and/or an aluminum halide solution is at least partially used to heat a polynucleate metal compound reactor and/or degrade a halite to halide.

18. The method of claim 1 or 2, wherein at least a portion of the electricity utilized by said electrolysis unit is obtained from steam energy, and wherein
said steam energy is obtained from the energy of formation of at least one selected from a list comprising: SO₂ from S and air or O₂; SO₃ from SO₂ and air or O₂; H₂SO₃ from SO₂ and H₂O; H₂SO₄ from SO₃ and H₂O; H₂SO₄ from SO₃, H₂SO₄ and H₂O; and any combination therein.

19. The method of claim 1 or 2, wherein said H₂SO₄ and/or said H₂SO₃ is manufactured by the sulfuric acid contract process.

20. The method of claim 1, 2 or 3, wherein at least a portion of said halide acid is used to produce at least one selected from a list comprising: a hypohalite, a halite, a halate, a halogen oxide and any combination therein.

21. The method of claim 1, 2 or 3, wherein said metal halide reaction with H₂SO₄ produces a salt of said metal comprising sulfate.

22. The method of claim 1, 2 or 3, wherein said metal halide reaction with H₂SO₃ produces a salt of said metal comprising sulfite.

23. The method of claim 3, wherein said SO₂ is reacted with a metal hydroxide to form said metal sulfite.

24. The method of claim 3, wherein said SO₂ is reacted with a metal carbonate to form said metal bi-sulfite.

25. The method of claim 1 or 2, wherein at least one selected from a list comprising: CaO, CaCO₃, Ca(OH)₂, SO₄, H₂O₂, a metal hydroxide and any combination therein is added to said aqueous reaction.

26. The method of claim 3, wherein said halogen oxide is manufactured from at least one selected from a list comprising said: halide acid, halite, halate and any combination therein.

27. The method of claim 1, 2, or 3, wherein said halide is chloride and/or bromide.

28. The method of claim 3, wherein said hypohalite is hypochlorite and/or said halite is chlorite and/or said halate is chlorate and/or said halogen oxide is chlorine dioxide.

29. The method of claim 3, wherein said hypohalite is hypobromite and/or said halite is bromite and/or said halate is bromate and/or said halogen oxide is bromine dioxide.

30. The method of claim 1, 2 or 3, wherein said metal is at least one selected from a list comprising a: Group IA metal, Group IIA metal, Group IIIB metal, Group VIII metal, Group 1B metal, Group IIB metal, Group IIA metal and any combination therein.

31. The method of claim 1, 2 or 3, wherein said metal is at least one selected from a list comprising: sodium, calcium, potassium, magnesium, aluminum, copper and any combination therein.

32. The method of claim 1 or 2, wherein there is no vehicular transportation of at least one selected from a list comprising said: halide acid, metal halide solution, H₂SO₄, H₂SO₃ and any combination therein.

33. The method of claim 1 or 2, wherein said aqueous reaction is performed with high shear.

34. The method of claim 1, 2 or 3, wherein said H₂SO₄ is manufactured by the sulfuric acid contact process, and wherein
SO₂ from the reaction of S in air and/or O₂ is at least partially used to manufacture at least one selected from a list comprising: H₂SO₃, sodium sulfite, a metal sulfite, sodium bisulfite, a metal bisulfite and any combination therein.

35. A method for the preparation of O₂, wherein said method comprises:
forming at least one selected from a list consisting of: SO₂ from S and air or O₂; SO₃ from SO₂ and air or O₂; H₂SO₃ from SO₂ and H₂O; H₂SO₄ from SO₃ and H₂O; H₂SO₄ from SO₃, H₂SO₄ and H₂O; and any combination therein, wherein
the energy of said formation is transferred to create steam, and wherein
said steam turns a steam turbine to create electricity, and wherein
said electricity is used in the electrolysis of H₂O to H₂ and O₂.

36. The method of claim 35, wherein said steam turns a steam engine, and wherein
said steam engine powers an air separation unit, and wherein said air separation unit produces O₂ and/or N₂.

37. The method of claim 35, wherein said electricity powers an air separation unit, and wherein said air separation unit produces O₂ and/or N₂.

38. The method of claim 35, 36 or 37, wherein said electricity is at least partially used in an electrolysis unit to convert said O₂ into O₃.

39. The method of claim 35, wherein said H₂ is at least partially used in a combustion engine turning a generator to make said electricity and/or in a fuel cell to make said electricity.

40. The method of claim 39, wherein said electricity is at least partially used in said electrolysis to form at least one selected from a list comprising: O₂, H₂, H₂O₂, a halide acid, a hypohalite, a halite, a halate, a hydroxide and any combination therein.

41. A manufacturing plant producing a polynucleate aluminum compound, said manufacturing plant comprising:
one or more units defining a process flow path in which a polynucleate aluminum compound is formed from the reaction of an aluminum halide solution with at least one selected from a list comprising: bauxite, alumina, aluminum hydroxide, aluminum metal and any combination therein, wherein
said unit(s) forming said polynucleate aluminum compound are downstream of one or more units defining a process flow path in which an aluminum halide solution is formed from the reaction of a halide acid with at least one selected from a list comprising: bauxite, alumina, aluminum hydroxide, aluminum metal and any combination therein, and wherein
said unit(s) forming said aluminum halide solution are downstream of one or more units defining a process flow path in which a halide acid is formed, and wherein
said unit(s) forming said halide acid comprise at least one electrolysis unit performing electrolysis on a metal salt of said halide and/or at least one unit reacting H₂SO₄ and/or H₂SO₃ with a metal salt of said halide.

42. A manufacturing plant producing a polynucleate metal compound, said manufacturing plant comprising:
one or more units defining a process flow path in which a polynucleate metal compound is formed from the reaction of a metal halide solution with at least one selected from a list comprising: bauxite, alumina, aluminum hydroxide, aluminum metal, a metal other than aluminum in the +2 or +3 valence state, a metal other than aluminum in the 0 valence state and capable of entering the +2 or +3 valence state and any combination therein, wherein
said unit(s) forming said polynucleate metal compound are downstream of one or more units defining a process flow path in which said metal halide solution is formed from the reaction of a halide acid with at least one of: bauxite, alumina, aluminum hydroxide, aluminum metal, a metal other than aluminum in the +2 or +3 valence state, a metal other than aluminum in the 0 valence state and capable of entering the +2 or +3 valence state and any combination therein, and wherein
said unit(s) forming said metal halide solution are downstream of one or more units defining a process flow path in which a halide acid is formed, and wherein
said unit(s) forming said halide acid comprise at least one electrolysis unit performing electrolysis on a salt of said halide and/or at least one unit reacting H₂SO₄ and/or H₂SO₃ with a salt of said halide.

43. A manufacturing plant producing at least one disinfectant and/or oxidant, said manufacturing plant comprising:
one or more units defining a process flow path in which a disinfectant is formed by electrolysis from a metal halide solution, said disinfectant comprising:
at least one selected from the list comprising a: halide acid, hypohalite, halite, halite, halogen oxide and any combination therein, wherein
the electricity for said electrolysis is at least partially prepared from one or more units creating said electricity from the energy of formation of at least one selected from list comprising: SO₂ from S and air or O₂; SO₃ from SO₂ and air or O₂; H₂SO₃ from SO₂ and H₂O; H₂SO₄ from SO₃ and H₂O; H₂SO₄ from SO₃, H₂SO₄ and H₂O; and any combination therein.

44. A manufacturing plant producing at least one disinfectant and/or oxidant, said manufacturing plant comprising:
one or more units defining a process flow path in which a halide acid is formed from the reaction of H₂SO₄ and/or H₂SO₃ with a metal halide solution, wherein
said unit(s) forming said halide acid is downstream of one or more units forming H₂SO₄ and/or H₂SO₃ from S, air or O₂ and H₂O.

45. The manufacturing plant of claim 41 or 42, wherein said aluminum halide solution is a waste catalyst regardless of formation.

46. The manufacturing plant of claim 41, 42, 43 or 44, wherein said metal halide solution is a waste brine regardless of formation.

47. The manufacturing plant of claim 41, 42, 43 or 44, wherein said metal halide is a waste catalyst regardless of formation.

48. The manufacturing plant of claim 41 or 42, further comprising at least one unit producing said H₂SO₄ and/or H₂SO₃ from S, air or O₂ and H₂O.

49. The manufacturing plant of claim 41 or 42, wherein at least a portion of the energy of formation of at least one selected from a list comprising: SO₂ from S and air or O₂; SO₃ from SO₂ and air or O₂; said H₂SO₃ from SO₂ and H₂O; said H₂SO₄ from SO₃ and H₂O; said H₂SO₄ from SO₃, H₂SO₄ and H₂O; and any combination therein is used to produce steam.

50. The manufacturing plant of claim 49, wherein at least a portion of said steam is used in at least one selected from a list comprising at least one: unit to refine bauxite to alumina, jacket of a polynucleate metal compound reactor, air dehydrating unit to evaporate water from a metal salt solution and/or cake, unit to degrade a halite to a halide, heat a unit containing S, turbine to produce electricity and any combination therein.

51. The manufacturing plant of claim 50, wherein said electricity is at least partially used in at least one electrolysis unit to form of at least one selected from a list comprising: O₂, O₃, H₂, H₂O₂, a halide acid, a hypohalite, a halite, a halate, a hydroxide and any combination therein.

52. The manufacturing plant of claim 51, wherein said H₂ is at least partially used in a combustion engine to turn a generator to make said electricity and/or used in a fuel cell to make said electricity for said electrolysis.

53. The manufacturing plant of claim 49, wherein said steam is at least partially used to power at least one air separation unit, and wherein said air separation unit(s) produces O₂.

54. The manufacturing plant of claim 53, comprising at least one electrolysis unit to convert said O₂ into O₃.

55. The manufacturing plant of claim 54, wherein at least a portion of the electricity for said electrolysis unit(s) is created in a steam turbine turned by said steam.

56. The manufacturing plant of claim 55, wherein said electricity is at least partially used to power at least one air separation unit, and wherein said air separation unit(s) to produce O₂.

57. The manufacturing plant of claim 56, comprising electrolysis and/or at least one electrolysis unit to convert said O₂ into O₃.

58. The manufacturing plant of claim 43 or 44, wherein said disinfectant is at least one of: O₂, O₃ and H₂O₂.

59. The manufacturing plant of claim 58, wherein said H₂SO₄ is used as a catalyst in the formation of said H₂O₂.

60. The manufacturing plant of claim 41, 42, 43 or 44, wherein H₂ is created in electrolysis.

61. The manufacturing plant of claim 60, wherein said H₂ is at least partially used in a combustion engine to turn a generator to make electricity and/or used in a fuel cell to make electricity for said electrolysis.

62. The manufacturing plant of claim 61, wherein said electricity is at least partially used in said electrolysis unit(s) to form of at least one selected from a list comprising: O₂, O₃, H₂, H₂O₂, a halide acid, a hypohalite, a halite, a halate, a hydroxide and any combination therein.

63. The manufacturing plant of claim 41 or 42, wherein the energy from the formation of said halide acid and/or said aluminum halide solution is at least partially used to heat said polynucleate metal compound reactor and/or degrade a halite to halide.

64. The manufacturing plant of claim 41 or 42, wherein at least a portion of the electricity utilized by said electrolysis unit(s) is obtained from a steam turbine, and wherein
the steam for said steam turbine is obtained from at least one unit forming of at least one selected from a list comprising: SO₂ from S and air or O₂; SO₃ from SO₂ and air or O₂; H₂SO₃ from SO₂ and H₂O; H₂SO₄ from SO₃ and H₂O; H₂SO₄ from SO₃, H₂SO₄ and H₂O; and any combination therein.

65. The manufacturing plant of claim 43, further comprising the formation of a halogen oxide, wherein at least one of said: halide acid, halite, halate and any combination therein is at least partially used in at least one unit to produce said halogen oxide.

66. The manufacturing plant of claim 41, 42, 43 or 44, wherein at least a portion of said halide acid is used in at least one unit to produce at least one selected from a list comprising: a hypohalite, a halite, a halate, a halogen oxide and any combination therein.

67. The manufacturing plant of claim 41, 42 or 44, wherein said metal halide reaction produces a salt of said metal comprising sulfate.

68. The manufacturing plant of claim 41, 42 or 44, wherein said metal halide reaction produces a salt of said metal comprising sulfite.

69. The manufacturing plant of claim 43, wherein said SO₂ is reacted with a metal hydroxide to form said metal sulfite.

70. The manufacturing plant of claim 43, wherein said SO₂ is reacted with a metal carbonate to form said metal bi-sulfite.

71. The manufacturing plant of claim 41 or 42, wherein at least one selected from a list comprising: CaO, CaCO₃, Ca(OH)₂, SO₄, H₂O₂, a metal hydroxide and any combination therein is added to said one or more units defining a process flow path in which a polynucleate metal compound is formed.

72. The manufacturing plant of claim 43, wherein said halogen oxide is manufactured from at least one selected from a list comprising said: halide acid, halite, halate and any combination therein.

73. The manufacturing plant of claim 41, 42, 43 or 44, wherein said halide is chloride and/or bromide.

74. The manufacturing plant of claim 43, wherein said hypohalite is hypochlorite and/or said halite is chlorite and/or said halate is chlorate and/or said halogen oxide is chlorine dioxide.

75. The manufacturing plant of claim 43, wherein said hypohalite is hypobromite and/or said halite is bromite and/or said halate is bromate and/or said halogen oxide is bromine dioxide.

76. The manufacturing plant of claim 41, 42, 43 or 44, wherein said metal is at least one selected from a list comprising a: Group IA metal, Group IIA metal, Group IIIB metal, Group VIII metal, Group 1B metal, Group IIB metal, Group IIA metal and any combination therein.

77. The manufacturing plant of claim 41, 42, 43 or 44, wherein said metal is at least one selected from a list comprising: sodium, calcium, potassium, magnesium, aluminum, copper and any combination therein.

78. The manufacturing plant of claim 41 or 42, wherein there is no vehicular transportation of at least one selected from a list comprising said: halide acid, metal halide solution, H₂SO₄, H₂SO₃ and any combination therein.

79. The manufacturing plant of claim 41 or 42, wherein said aqueous reaction is performed with high shear.

80. The manufacturing plant of claim 41, 42, 43 or 44, wherein said H₂SO₄ is manufactured by the sulfuric acid contact process, and wherein
SO₂ from the reaction of S in air and/or O₂ is at least partially used to manufacture at least one selected from a list comprising: H₂SO₃, sodium sulfite, a metal sulfite, sodium bisulfite, a metal bisulfite and any combination therein.
